(19) United States
(12) Patent Application Publication
(10) Pub. No.: US 2024/0346574 A1
(43) Pub. Date: Oct. 17, 2024

(54) ON-DEMAND RENTAL FACILITY MANAGEMENT SYSTEM

(71) Applicant: TAISHO SKY BUILDING, INC., Tokyo (JP)

(72) Inventor: Kazuharu Ishida, Tokyo (JP)

(21) Appl. No.: 18/751,251

(22) Filed: Jun. 23, 2024

Related U.S. Application Data
(63) Continuation of application No. PCT/JP2021/047469, filed on Dec. 22, 2021.

(51) Int. Cl. G06Q 30/0645

(52) U.S. Cl. CPC G06Q 30/0645

(57) ABSTRACT

An on-demand rental facility management system includes a room, a management server for managing the room, a user input means for receiving information input, an accommodation means for storing an item, and a transportation robot for transporting the item. The management server includes a facility reservation receiving unit for receiving a reservation for the room via the user input means, and an item transportation control system. The item transportation control system includes a transportation receiving unit for receiving transportation of an object, an item identification information acquisition unit for acquiring item identification information for identifying the object stored in the accommodation means, and a transportation control unit for causing the transportation robot to transport the object from the accommodation means to the room on the basis of the item identification information and facility reservation information on the reservation for the room.

### RELATED APPLICATIONS

The present application is a continuation of International Patent Application No. PCT/JP2021/047469, filed Dec. 22, 2021, which is hereby incorporated by reference in its entirety.

### TECHNICAL FIELD

This disclosure relates to an on-demand reservation system for setting a usage time and renting a facility to a user.

### BACKGROUND

Conventionally, systems have been proposed for renting facilities such as empty conference rooms of buildings, officed, or hotels to general users. For example, a conventional rental booth management system may include a plurality of rental booths (on-demand rental facilities) for rent, a power supply unit provided in each booth, and a management device for managing each booth. The management device includes an input unit for receiving an input for allowing the user to select a booth that the user desires to use and an input for allowing the user to set usage time of the selected booth, a receiving unit for receiving a usage fee for the booth, and a control unit for controlling a management system. The control unit performs control to calculate the usage fee for the booth, to store various information input via the input unit in a storage unit, and to supply power to the booth. The control to calculate the usage fee for the booth calculates the usage fee on the basis of the booth selected via the input unit and the usage time of the booth. When it is verified that the receiving unit receives the usage fee for the booth, the control to store the various information input via the input unit in the storage unit stores the booth for which the usage fee is received by the receiving unit and the usage time in the storage unit. The control to supply power to the booth causes the power supply unit of the booth to supply power only for the usage time on the basis of the information stored in the storage unit.

Here, the user of the on-demand rental facility may want to store items such as tools and equipment used in the on-demand rental facility in a storage location such as a locker. In this regard, conventional rental booth management systems may include a locker device attached to the management device. The management device can perform both operations to use the rental booth and to use the locker device.

However, in conventional rental booth management systems, since the user of the on-demand rental facility must go to the storage location to pick up items such as tools and equipment to be used in the on-demand rental facility by oneself, this may lead to reduced user convenience.

### SUMMARY

An object of the present invention is to provide an on-demand rental facility management system capable of improving user convenience.

The on-demand rental facility management system according to the present invention is an on-demand rental facility management system including: on-demand rental facility in which usage time is set and facility is rented to a user; a management server for managing the on-demand rental facility; and a user input means that is connected to the management server via a communication line and receives information input by the user of the on-demand rental facility, the on-demand rental facility management system including: a storage location for storing an item delivered by a delivery agent; and a transportation means that is connected to the management server via the communication line and moves between the on-demand rental facility and the storage location to transport the item, in which the management server includes: a storage unit for storing information; a facility reservation receiving unit for storing facility reservation information on the user and reservation date and time of the on-demand rental facility in the storage unit by receiving a reservation for the on-demand rental facility via the user input means; a transportation receiving unit for receiving transportation of an object, which is an item related to the user of the on-demand rental facility, via the user input means; an item identification information acquisition unit for acquiring item identification information for identifying the object stored in the storage location when the transportation of the object is received by the transportation receiving unit; and a transportation control unit for causing the transportation means to transport the object from the storage location to the on-demand rental facility at the reservation date and time of the on-demand rental facility on the basis of the facility reservation information stored in the storage unit and the item identification information acquired by the item identification information acquisition unit.

According to the present invention, the transportation control unit causes the transportation means to transport the object from the storage location to the on-demand rental facility at the reservation date and time of the on-demand rental facility on the basis of the facility reservation information stored in the storage unit and the item identification information acquired by the item identification information acquisition unit, so that the user can receive the object in the on-demand rental facility at the reservation date and time of the on-demand rental facility by requesting the delivery agent to deliver the object to the storage location. Therefore, the on-demand rental facility management system can improve user convenience.

In the present invention, it is preferred that the on-demand rental facility is a room provided inside a building, the building includes a locking device of the building for locking and unlocking the building, and the management server includes a building unlocking key issuing unit for issuing a building unlocking key for unlocking the locking device of the building to the user of the on-demand rental facility and the transportation means on the basis of the facility reservation information stored in the storage unit.

With such a configuration, the building unlocking key issuing unit issues the building unlocking key for unlocking the locking device of the building to the user of the on-demand rental facility and the transportation means on the basis of the facility reservation information stored in the storage unit, so that the user can enter inside of the building, and the transportation control unit can cause the transportation means to transport the object from the storage location to the inside of the building at the reservation date and time of the on-demand rental facility. Therefore, the on-demand rental facility management system can further improve user convenience.

In the present invention, it is preferred that the on-demand rental facility includes a locking device of the on-demand rental facility for locking and unlocking the on-demand rental facility, and the management server includes a facility unlocking key issuing unit for issuing a facility unlocking key for unlocking the locking device of the on-demand rental facility to the user of the on-demand rental facility and the transportation means on the basis of the facility reservation information stored in the storage unit.

With such a configuration, the facility unlocking key issuing unit issues the facility unlocking key for unlocking the locking device of the on-demand rental facility to the user of the on-demand rental facility and the transportation means on the basis of the facility reservation information stored in the storage unit, so that the user can enter inside of the on-demand rental facility, and the transportation control unit can cause the transportation means to transport the object from the storage location to the inside of the on-demand rental facility at the reservation date and time of the on-demand rental facility. Therefore, the on-demand rental facility management system can further improve user convenience.

In the present invention, it is preferred that the on-demand rental facility management system includes an accommodation means that is connected to a communication line and has an accommodation unit as a plurality of the storage locations for accommodating items, in which the item identification information acquisition unit acquires information for identifying the accommodation unit that accommodates the object as the item identification information.

With such a configuration, the item identification information acquisition unit acquires the information for identifying the accommodation unit that accommodates the object as the item identification information, so that the transportation means can easily identify the object stored in the storage location and simplify a configuration of the on-demand rental facility management system, for example, without identifying a shape and the like of the object using technology such as image processing, by acquiring the information for identifying the accommodation unit that accommodates the object (for example, information such as a location and an identification number of the accommodation unit) by the item identification information acquisition unit via the user or the delivery agent.

In the present invention, it is preferred that the management server includes an accommodation reservation receiving unit for storing accommodation reservation information on a user and reservation date and time of the accommodation unit in the storage unit in association with the facility reservation information by receiving a reservation for the accommodation unit via the user input means, and the item identification information acquisition unit acquires the accommodation reservation information stored in the storage unit as the item identification information.

With such a configuration, the accommodation reservation receiving unit stores the accommodation reservation information on the user and the reservation date and time of the accommodation unit in the storage unit in association with the facility reservation information by receiving the reservation for the accommodation unit via the user input means, so that the user can reserve the accommodation unit as well as the on-demand rental facility. Therefore, the user can reliably store the object in the storage location.

In addition, the item identification information acquisition unit acquires the accommodation reservation information stored in the storage unit as the item identification information, so that the transportation means can easily identify the object stored in the storage location and simplify the configuration of the on-demand rental facility management system, for example, without identifying the shape and the like of the object using the technology such as the image processing, by acquiring the accommodation reservation information stored in the storage unit as the item identification information by the item identification information acquisition unit.

In the present invention, the management server preferably includes an accommodation reservation information notifying unit for notifying the delivery agent of the accommodation reservation information stored in the storage unit.

With such a configuration, the accommodation reservation information notifying unit notifies the delivery agent of the accommodation reservation information stored in the storage unit, so that the delivery agent can deliver the object to the accommodation unit reserved by the user on the basis of the accommodation reservation information notified by the accommodation reservation information notifying unit. Therefore, the user can reliably receive the object in the on-demand rental facility at the reservation date and time of the demand rental facility without notifying the delivery agent of the accommodation reservation information.

In the present invention, it is preferred that the user input means includes a display unit for displaying information, and the management server includes an availability display unit for displaying availability of the accommodation unit on the display unit of the user input means on the basis of the accommodation reservation information stored in the storage unit.

With such a configuration, the availability display unit displays the availability of the accommodation unit on the display unit of the user input means on the basis of the accommodation reservation information stored in the storage unit, so that the user can reserve the accommodation unit with reference to the availability of the accommodation unit displayed on the display unit of the user input means.

In the present invention, it is preferred that the storage unit stores attribute information on an attribute of the accommodation unit for selecting the accommodation unit, and the management server includes: an accommodation unit information display unit for displaying the attribute of the accommodation unit on the display unit of the user input means on the basis of the attribute information stored in the storage unit; and an accommodation unit selection unit for allowing the user of the on-demand rental facility to select the accommodation unit displayed on the display unit of the user input means via the user input means.

With such a configuration, the accommodation unit information display unit displays the attribute of the accommodation unit on the display unit of the user input means on the basis of the attribute information stored in the storage unit, and the accommodation unit selection unit allows the user of the on-demand rental facility to select the accommodation unit displayed on the display unit of the user input means via the user input means, so that the user can select and reserve the accommodation unit having the attribute desired to be used with reference to the attribute of a plurality of the accommodation units displayed on the display unit of the user input means.

Here, the attribute of the accommodation unit is the attribute for selecting the accommodation unit. Specifically, the attribute of the accommodation unit can include, for example, features such as the position, size, and shape of the accommodation unit, as well as functions such as refrigeration, freezing, and temperature and humidity adjustment.

In the present invention, it is preferred that the storage unit stores the attribute information on the attribute of the accommodation unit for selecting the accommodation unit, and the management server includes: an attribute information display unit for displaying the attribute of the accommodation unit on the display unit of the user input means on the basis of the attribute information stored in the storage unit; an attribute selection unit for allowing the user of the on-demand rental facility to select the attribute of the accommodation unit displayed on the display unit of the user input means via the user input means; and an accommodation unit determination unit for determining the accommodation unit to be used by the user of the on-demand rental facility on the basis of the attribute of the accommodation unit selected by the user of the on-demand rental facility.

With such a configuration, the attribute information display unit displays the attribute of the accommodation unit on the display unit of the user input means on the basis of the attribute information stored in the storage unit, the attribute selection unit allows the user of the on-demand rental facility to select the attribute of the accommodation unit displayed on the display unit of the user input means via the user input means. Then, the accommodation unit determination unit determines the accommodation unit to be used by the user of the on-demand rental facility on the basis of the attribute of the accommodation unit selected by the user of the on-demand rental facility. Therefore, the user can cause the accommodation unit determination unit to automatically determine and reserve the accommodation unit having a desired attribute by selecting the attribute of the accommodation unit desired to be used with reference to the attributes of the plurality of accommodation units displayed on the display unit of the user input means.

In the present invention, it is preferred that the accommodation reservation receiving unit receives the reservation for the accommodation unit at reservation date and time different from the reservation date and time of the on-demand rental facility for which the reservation is received by the facility reservation receiving unit.

With such a configuration, the accommodation reservation receiving unit receives the reservation for the accommodation unit at the reservation date and time different from the reservation date and time of the on-demand rental facility for which the reservation is received by the facility reservation receiving unit, so that the user can store the object in the storage location, for example, before the reservation date and time of the on-demand rental facility, and can store the object in the storage location after the reservation date and time of the on-demand rental facility passes and until the next time the on-demand rental facility is used.

In the present invention, it is preferred that the transportation control unit causes the transportation means to transport the object from the on-demand rental facility to the accommodation unit for which the reservation is received by the accommodation reservation receiving unit after the reservation date and time of the on-demand rental facility passes on the basis of the facility reservation information and the accommodation reservation information stored in the storage unit.

With such a configuration, the transportation control unit causes the transportation means to transport the object from the on-demand rental facility to the accommodation unit for which the reservation is received by the accommodation reservation receiving unit after the reservation date and time of the on-demand rental facility passes on the basis of the facility reservation information and the accommodation reservation information stored in the storage unit, so that the user can accommodate the object in the accommodation unit for which the reservation is received by the accommodation reservation receiving unit after the reservation date and time of the on-demand rental facility passes, without transporting the object from the on-demand rental facility to the accommodation unit by oneself. Therefore, the on-demand rental facility management system can further improve user convenience.

In the present invention, it is preferred that the accommodation unit includes a locking device for locking and unlocking the accommodation unit, and the management server includes: a delivery receiving unit for receiving delivery of the object to the accommodation unit for which the reservation is received by the accommodation reservation receiving unit; an accommodation unlocking key issuing unit for issuing an accommodation unlocking key for unlocking the locking device of the accommodation unit that is a delivery destination for which the delivery is received by the delivery receiving unit; and a delivery information notifying unit for notifying the delivery agent of the accommodation reservation information on the accommodation unit of the delivery destination stored in the storage unit, and notifying the delivery agent of the accommodation unlocking key.

With such a configuration, the delivery information notifying unit notifies the delivery agent of the accommodation reservation information on the accommodation unit of the delivery destination stored in the storage unit, and notifies the delivery agent of the accommodation unlocking key, so that the user can cause the delivery agent to deliver the object to the accommodation unit of the delivery destination without notifying the delivery agent of the accommodation unit of the delivery destination and the accommodation unlocking key.

In the present invention, it is preferred that the delivery receiving unit receives collection information on collection of the object, and the delivery information notifying unit notifies the delivery agent of the collection information.

With such a configuration, the delivery information notifying unit notifies the delivery agent of the collection information, so that the delivery agent can collect the object on the basis of the collection information. Therefore, the user can cause the delivery agent to collect the object, for example, from the user's home without directly requesting the delivery agent to collect the object, so that the on-demand rental facility management system can further improve user convenience.

In the present invention, it is preferred that the accommodation unit includes a locking device for locking and unlocking the accommodation unit, the management server includes: a recovery receiving unit for receiving recovery of the object in the accommodation unit for which the reservation is received by the accommodation reservation receiving unit; an accommodation unlocking key issuing unit for issuing an accommodation unlocking key for unlocking the locking device of the accommodation unit that is a recovery destination for which the recovery is received by the recovery receiving unit; and a recovery information notifying unit for notifying the delivery agent of the accommodation reservation information on the accommodation unit of the recovery destination stored in the storage unit, and notifying the delivery agent of the accommodation unlocking key.

With such a configuration, the recovery information notifying unit notifies the delivery agent of the accommodation reservation information on the accommodation unit of the recovery destination stored in the storage unit, and notifies the delivery agent of the accommodation unlocking key, so that the user can cause the delivery agent to recover the object from the accommodation unit of the recovery destination without informing the delivery agent of the accommodation unit of the recovery destination and the accommodation unlocking key.

In the present invention, it is preferred that the recovery receiving unit receives shipping information on shipping of the object, and the recovery information notifying unit notifies the delivery agent of the shipping information.

With such a configuration, the recovery information notifying unit notifies the delivery agent of the shipping information, so that the delivery agent can ship the object on the basis of shipping address information. Therefore, the user can cause the delivery agent to ship the object to, for example, the user's home without directly requesting the delivery agent to ship the object, so that the on-demand rental facility management system can further improve user convenience.

In the present invention, it is preferred that the accommodation unit includes a locking device for locking and unlocking the accommodation unit, the management server includes: a delivery receiving unit for receiving delivery of the object to the accommodation unit for which the reservation is received by the accommodation reservation receiving unit; an accommodation unlocking key issuing unit for issuing an accommodation unlocking key for unlocking the locking device of the accommodation unit that is a delivery destination for which the delivery is received by the delivery receiving unit; a delivery information notifying unit for notifying the delivery agent of the accommodation unit of the delivery destination and the accommodation unlocking key; a recovery receiving unit for receiving recovery of the object in the accommodation unit for which the reservation is received by the accommodation reservation receiving unit; an accommodation unlocking key issuing unit for issuing an accommodation unlocking key for unlocking the locking device of the accommodation unit that is a recovery destination for which the recovery is received by the recovery receiving unit; a recovery information notifying unit for notifying the delivery agent of the accommodation unit of the recovery destination and the accommodation unlocking key; a rental information acquisition unit for acquiring rental information on a rental item that can be rented at the reservation date and time of the accommodation unit on the basis of the accommodation reservation information stored in the storage unit and storing the rental information in the storage unit; a rental information display unit for displaying the rental item that can be rented at the reservation date and time of the accommodation unit on a display unit of the user input means on the basis of the rental information stored in the storage unit; and a rental item selection unit for allowing the user of the on-demand rental facility to select the rental item displayed on the display unit of the user input means via the user input means, and the object is the rental item selected by the rental item selection unit.

With such a configuration, the rental information acquisition unit acquires the rental information on the rental item that can be rented at the reservation date and time of the accommodation unit on the basis of the accommodation reservation information stored in the storage unit and stores the rental information in the storage unit, and the rental information display unit displays the rental item that can be rented at the reservation date and time of the accommodation unit on the display unit of the user input means on the basis of the rental information stored in the storage unit. Then, the rental item selection unit allows the user of the on-demand rental facility to select the rental item displayed on the display unit of the user input means via the user input means. Therefore, the user can select the rental item desired to be used with reference to the rental item displayed on the display unit of the user input means. Further, since the object is the rental item selected by the rental item selection unit, the user can cause a rental agent (the delivery agent) to deliver and recover the rental item. Therefore, the on-demand rental facility management system can further improve user convenience.

Note that the rental information acquisition unit may acquire the rental information on the basis of information stored in advance in the storage unit, or may acquire the rental information by making an inquiry to the rental agent or the like.

In the present invention, it is preferred that the accommodation unlocking key issuing unit includes: a transportation unlocking key issuing unit for issuing, to the transportation means, a transportation unlocking key for unlocking the locking device of the accommodation unit for which the reservation is received by the accommodation reservation receiving unit; and an agent unlocking key issuing unit for issuing, to the delivery agent, an agent unlocking key for unlocking the locking device of the accommodation unit for which the reservation is received by the accommodation reservation receiving unit, and being different from the transportation unlocking key.

With such a configuration, the transportation unlocking key issuing unit issues the transportation unlocking key to the transportation means, and the agent unlocking key issuing unit issues the agent unlocking key different from the transportation unlocking key to the agent, so that the on-demand rental facility management system can suppress problems such as the object being taken away by the agent, and can improve safety.

In the present invention, the management server preferably includes an agent unlocking key setting unit for enabling or disabling the agent unlocking key on the basis of a predetermined condition.

With such a configuration, the agent unlocking key setting unit enables or disables the agent unlocking key on the basis of the predetermined condition, so that the on-demand rental facility management system can suppress unlocking of the accommodation unit by the agent, and can improve safety of the accommodation unit.

In the present invention, it is preferred that the agent unlocking key setting unit determines a specific time period to enable the agent unlocking key on the basis of the accommodation reservation information stored in the storage unit, enables the agent unlocking key at a start of the specific time period, and disables the agent unlocking key at an end of the specific time period.

With such a configuration, the agent unlocking key setting unit enables the agent unlocking key at the start of the specific time period, and disables the agent unlocking key at the end of the specific time period, so that the on-demand rental facility management system can suppress unlocking of the accommodation unit by the agent outside of the specific time period, and can improve the safety of the accommodation unit.

In the present invention, the agent unlocking key setting unit preferably disables the agent unlocking key after the agent unlocking key is used.

With such a configuration, the agent unlocking key setting unit disables the agent unlocking key after the agent unlocking key is used, so that a validity period of the agent unlocking key can be shortened compared to, for example, a case of disabling the agent unlocking key at the end of the specific time period. Therefore, the on-demand rental facility management system can suppress unlocking of the accommodation unit by the agent, and can improve safety of the accommodation unit.

In the present invention, it is preferred that the management server includes a transportation unlocking key setting unit for enabling or disabling the transportation unlocking key on the basis of a predetermined condition, and the transportation unlocking key setting unit enables the transportation unlocking key after disabling the agent unlocking key.

With such a configuration, since the transportation unlocking key setting unit enables the transportation unlocking key after disabling the agent unlocking key, the agent unlocking key and the transportation unlocking key are not enabled at the same time. Therefore, the on-demand rental facility management system can suppress unlocking of the accommodation unit by the agent, and can improve safety of the accommodation unit.

In the present invention, the management server preferably includes a changing unit for changing at least one of a usage fee for the accommodation unit and a usage period of the accommodation unit on the basis of a predetermined condition.

With such a configuration, the changing unit changes at least one of the usage fee for the accommodation unit and the usage period of the accommodation unit on the basis of the predetermined condition, so that the on-demand rental facility management system can change at least one of the usage fee for the accommodation unit and the usage period of the accommodation unit on the basis of, for example, attributes of the user such as being a very important person (VIP), and can promote use of the accommodation unit by the user of the on-demand rental facility.

In the present invention, it is preferred that the accommodation means includes: a first accommodation means disposed at a predetermined location; and a second accommodation means disposed at a location different from the first accommodation means, the storage unit stores location information on placement locations of the first accommodation means and the second accommodation means, and the management server includes a location information display unit for displaying the placement locations of the first accommodation means and the second accommodation means on a display unit of the user input means on the basis of the location information stored in the storage unit.

With such a configuration, the location information display unit displays the placement locations of the first accommodation means and the second accommodation means on the display unit of the user input means on the basis of the location information stored in the storage unit, so that the user can select and reserve the accommodation means desired to be used with reference to the placement locations of the first accommodation means and the second accommodation means displayed on the display unit of the user input means. Therefore, the on-demand rental facility management system can further improve user convenience.

In the present invention, it is preferred that the management server includes: a sum calculation unit for calculating a sum of a usage fee for the accommodation unit and a usage fee for the on-demand rental facility; and a settlement receiving unit for receiving settlement for the sum of usage fees calculated by the sum calculation unit.

With such a configuration, the sum calculation unit calculates the sum of the usage fee for the accommodation unit and the usage fee for the on-demand rental facility, and the settlement receiving unit receives the settlement for the sum of the usage fees calculated by the sum calculation unit, so that the user can verify the sum of the usage fee for the accommodation unit and the usage fee for the on-demand rental facility, and can pay the usage fees in one settlement.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of an on-demand rental facility management system according to a first embodiment of the present invention.

FIG. 2 is a perspective view illustrating an appearance of an accommodation means.

FIG. 3 is a block diagram illustrating functions of the on-demand rental facility management system.

FIG. 4 is a block diagram illustrating functions of an item transportation control system.

FIG. 5 is a block diagram illustrating functions of an accommodation reservation control system.

FIG. 6 is a block diagram illustrating functions of a delivery and recovery control system.

FIG. 7 is a block diagram illustrating functions of an unlocking key control system.

FIG. 8 is a block diagram illustrating functions of a usage fee control system.

FIG. 9 is a flowchart illustrating an operation of the on-demand rental facility management system.

FIG. 10 is a flowchart illustrating an operation of locker reservation processing.

FIG. 11 is a diagram illustrating a display unit of a user input means displaying placement locations of first accommodation means and second accommodation means.

FIG. 12 is a diagram illustrating the display unit of the user input means displaying attributes of a plurality of lockers in the first accommodation means.

FIG. 13 is a diagram illustrating the display unit of the user input means displaying availability of the locker.

FIG. 14 is a flowchart illustrating an operation of transportation reservation processing.

FIG. 15 is a flowchart illustrating an operation of delivery and recovery reservation processing.

FIG. 16 is a flowchart illustrating an operation of unlocking key related processing.

FIG. 17 is a flowchart illustrating an operation of setting processing for various unlocking keys.

FIG. 18 is a flowchart illustrating an operation of usage fee related processing.

FIG. 19 is a block diagram illustrating functions of the accommodation reservation control system according to a second embodiment of the present invention.

FIG. 20 is a flowchart illustrating an operation of the locker reservation processing.

FIG. 21 is a diagram illustrating the display unit of the user input means displaying the attributes of the lockers in the first accommodation means.

### DETAILED DESCRIPTION

Hereinafter, a first embodiment of the present invention will be described with reference to the drawings.

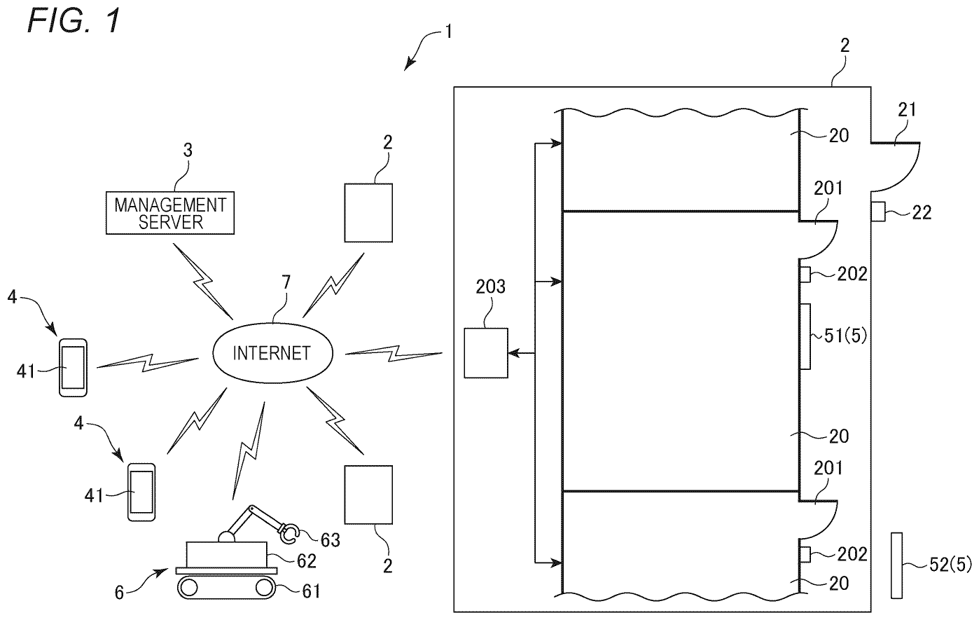

FIG. 1 is a schematic configuration diagram of an on-demand rental facility management system according to the first embodiment of the present invention.

As illustrated in FIG. 1, an on-demand rental facility management system 1 includes: a building 2 having a plurality of rooms 20 as an on-demand rental facility in which usage time is set and facility is rented to a user; a management server 3 for managing the rooms 20; a user input means 4 for receiving information input by the user of the room 20; an accommodation means 5 having a plurality of accommodation units for accommodating items; and a transportation robot 6 as a transportation means moving between each room 20 and the accommodation means 5 to transport the item.

The building 2, the management server 3, the user input means 4, the accommodation means 5, and the transportation robot 6 are communicably connected to each other via the Internet 7, which is a public network as a communication line.

As described above, the building 2 includes the plurality of rooms 20 provided inside the building 2, a doorway 21, and a building-side locking device 22 as a locking device of the building for locking and unlocking the doorway 21.

Each room 20 includes a doorway 201 and a facility-side locking device 202 for locking and unlocking the doorway 201. Each room 20 also includes a communication terminal device 203 such as a modem or router connected via a local area network (LAN). The communication terminal device 203 is connected to the management server 3 via the Internet 7.

In the present embodiment, the building-side locking device 22 is unlocked by receiving an unlocking key input or by receiving an unlocking key via the Internet 7, and is automatically locked by closing a door of the doorway 21. Further, the facility-side locking device 202 is unlocked by receiving the unlocking key input or by receiving an unlocking key via the Internet 7, and is automatically locked by closing a door of the doorway 201. Note that the building-side locking device 22 and the facility-side locking device 202 may be able to be manually locked and unlocked, or may be able to be locked and unlocked by the management server 3 via the Internet 7.

The user input means 4 is a mobile phone, a smart phone, a personal computer, or the like possessed by a user who wishes to use the room 20. In the present embodiment, the user input means 4 is a smart phone for receiving the information input to the management server 3 by the user. The user input means 4 includes a touch panel 41, can receive the information input through the touch panel 41, and can display information through the touch panel 41. In other words, the touch panel 41 functions as a display unit for displaying the information.

The accommodation means 5 includes a first accommodation means 51 disposed at a predetermined location and a second accommodation means 52 disposed at a location different from the first accommodation means 51. Here, in the present embodiment, the first accommodation means 51 is disposed inside the building 2. Further, the second accommodation means 52 is disposed not near the building 2 but in the premises of the nearest station to the building 2.

The user can refer to the room 20 desired to be used and the accommodation means 5 and reserve the room 20 and the accommodation means 5 by being connected to the management server 3 via the user input means 4.

The transportation robot 6 includes a traveling unit 61 capable of traveling on a floor surface, a control unit 62 mounted on the traveling unit 61 and for controlling the entire transportation robot 6, and an arm unit 63 controlled by the control unit 62 and for holding an item to be transported.

The control unit 62 can perform various functions of the transportation robot 6, for example, unlock the building-side locking device 22 and the facility-side locking device 202 via the Internet 7, take out the item accommodated in the accommodation unit of the accommodation means 5 by the arm unit 63 and hold the item by the arm unit 63, and travel on the floor surface with the traveling unit 61 and transport the item held by the arm unit 63 to the room 20.

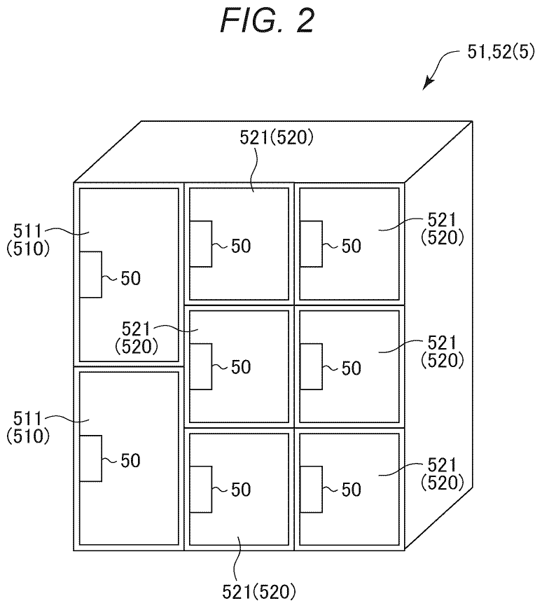

FIG. 2 is a perspective view illustrating an appearance of the accommodation means.

As illustrated in FIG. 2, the first accommodation means 51 and the second accommodation means 52 have a plurality of lockers 510 and 520 as a plurality of accommodation units for accommodating the item.

The locker 510 has, for example, a space enough to accommodate a golf bag inside the locker. In addition, the locker 520 has a smaller space than the locker 510, for example, a space enough to accommodate a backpack inside the locker.

Therefore, in the present embodiment, the lockers 510 and 520 function as storage locations for storing the items, and can store the items delivered by a delivery agent.

The lockers 510 and 520 respectively include doors 511 and 521 for blocking an internal space of the lockers, and accommodation-side locking devices 50 as locking devices of the accommodation unit for locking and unlocking the doors 511 and 521.

In the present embodiment, the accommodation-side locking devices 50 are unlocked by receiving the unlocking key input or by receiving the unlocking key via the Internet 7, and are automatically locked by closing the doors 511 and 521. Note that the accommodation-side locking device 50 may be able to be manually locked and unlocked, or may be able to be locked and unlocked by the management server 3 via the Internet 7.

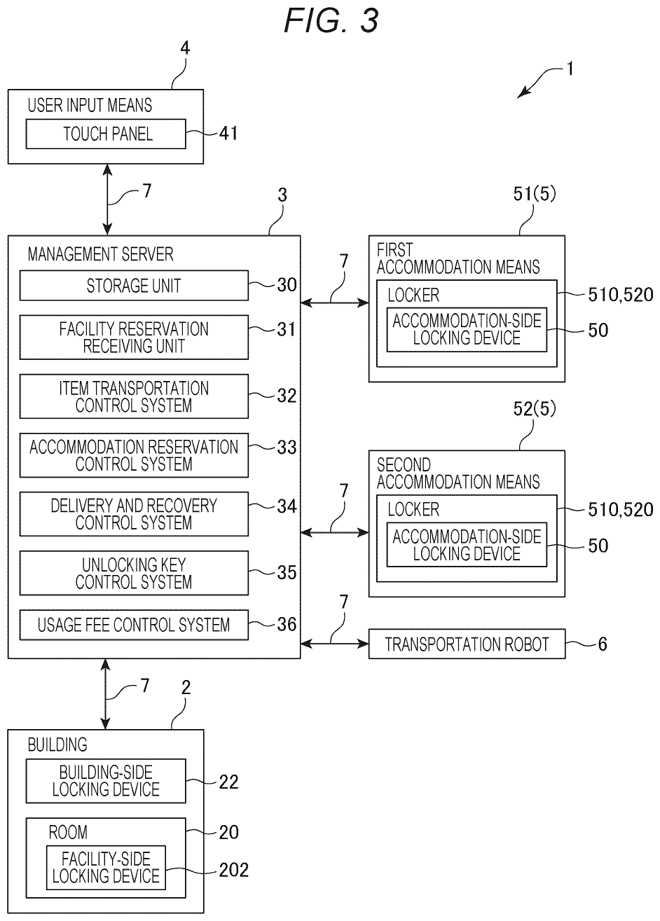

FIG. 3 is a block diagram illustrating functions of the on-demand rental facility management system.

The management server 3 includes a central processing unit (CPU), a memory, and the like, and performs information processing according to a predetermined program stored in the memory.

As illustrated in FIG. 3, the management server 3 includes a storage unit 30, a facility reservation receiving unit 31, an item transportation control system 32, an accommodation reservation control system 33, a delivery and recovery control system 34, an unlocking key control system 35, and a usage fee control system 36.

The storage unit 30 is a memory or a hard disk drive (HDD) for storing information.

Note that in the present embodiment, the storage unit 30 includes the memory or the HDD, but may include a solid state drive (SDD), a network attached storage (NAS), or the like, or include a cloud service.

Further, functions of the management server 3 are performed according to the program stored in the storage unit 30, but may be implemented by independent devices or implemented by cloud computing.

The facility reservation receiving unit 31 stores the facility reservation information on the user and reservation date and time (usage start time and usage end time) of the room 20 in the storage unit 30 by receiving a reservation for the room 20 via the user input means 4.

As described above, the user can refer to the room 20 desired to be used and reserve the room 20 by being connected to the management server 3 via the user input means 4.

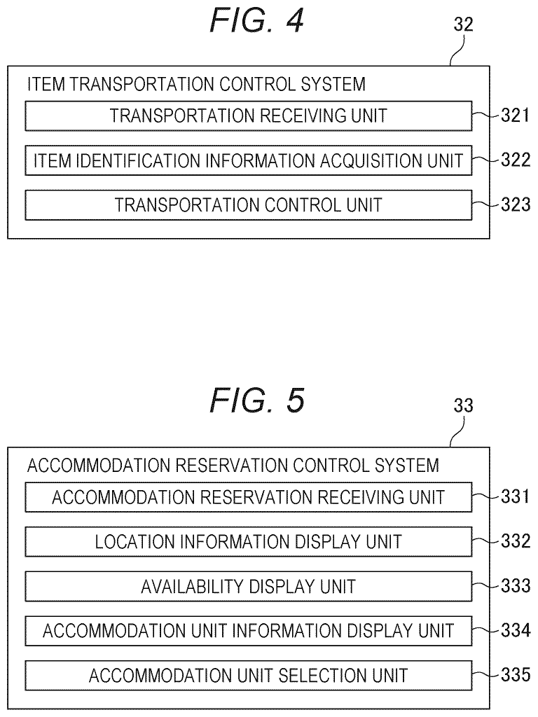

FIG. 4 is a block diagram illustrating functions of the item transportation control system.

The item transportation control system 32 is a control system for causing the transportation robot 6 to move between each room 20 and the accommodation means 5 to carry the item. As illustrated in FIG. 4, the item transportation control system 32 includes a transportation receiving unit 321, an item identification information acquisition unit 322, and a transportation control unit 323.

The transportation receiving unit 321 receives transportation of an object, which is an item related to the user of the room 20, via the user input means 4.

The item identification information acquisition unit 322 acquires item identification information for identifying objects stored in the lockers 510 and 520 when the transportation reception unit 321 receives the transportation of the object.

The transportation control unit 323 causes the transportation robot 6 to transport the objects from the lockers 510 and 520 to the room 20 at the reservation date and time of the room 20 on the basis of the facility reservation information stored in the storage unit 30 and the item identification information acquired by the item identification information acquisition unit 322. Specifically, the transportation control unit 323 causes the transportation robot 6 to transport the objects from the lockers 510 and 520 to the room 20 a little before (10 minutes before in the present embodiment) the usage start time of the room 20.

Further, the transportation control unit 323 causes the transportation robot 6 to transport the objects from the room 20 to the lockers 510 and 520 after the reservation date and time of the room 20 passes on the basis of the facility reservation information stored in the storage unit 30 and the item identification information acquired by the item identification information acquisition unit 322. Specifically, the transportation control unit 323 causes the transportation robot 6 to transport the objects from the room 20 to the lockers 510 and 520 a little after (10 minutes after in the present embodiment) the usage end time of the room 20.

Note that in the present embodiment, the transportation control unit 323 causes the transportation robot 6 to transport the objects from the room 20 to the lockers 510 and 520 after the reservation date and time of the room 20 passes, but it may be configured such that the transportation robot 6 does not transport the objects from the room 20 to the lockers 510 and 520 after the reservation date and time of the room 20 passes. In this case, the user may transport the objects from room 20 to lockers 510 and 520 by oneself.

FIG. 5 is a block diagram illustrating functions of the accommodation reservation control system.

The accommodation reservation control system 33 is a control system for allowing the user of the room 20 to reserve the lockers 510 and 520 desired to be used via the user input means 4. As illustrated in FIG. 5, the accommodation reservation control system 33 includes an accommodation reservation receiving unit 331, a location information display unit 332, an availability display unit 333, an accommodation unit information display unit 334, and an accommodation unit selection unit 335.

The storage reservation reception unit 331 stores accommodation reservation information on the user and the reservation date and time (usage start time and usage end time) of the lockers 510 and 520 in the storage unit 30 in association with the facility reservation information by receiving reservation for the lockers 510 and 520 via the user input means 4.

Here, the accommodation reservation receiving unit 331 can receive the reservation for the lockers 510 and 520 at reservation date and time different from the reservation date and time of the room 20 for which the reservation is received by the facility reservation receiving unit 31. In other words, the user can set the usage start time of the lockers 510 and 520 at a time different from the usage start time of the room 20, and set the usage end time of the lockers 510 and 520 at a time different from the usage end time of the room 20.

As described above, the user can refer to the lockers 510 and 520 desired to be used and reserve the lockers 510 and 520 by being connected to the management server 3 via the user input means 4.

Note that in the present embodiment, the accommodation reservation receiving unit 331 can receive the reservation for the lockers 510 and 520 at the reservation date and time different from the reservation date and time of the room 20 for which the reservation is received by the facility reservation receiving unit 31, but the accommodation reservation receiving unit 331 may be able to receive only reservation for the lockers 510 and 520 at the same reservation date and time as the reservation date and time of the room 20 for which the reservation is received by the facility reservation receiving unit 31.

The location information display unit 332 displays placement locations of the first accommodation means 51 and the second accommodation means 52 on the touch panel 41 of the user input means 4 on the basis of location information stored in the storage unit 30.

The availability display unit 333 displays availability of the lockers 510 and 520 on the touch panel 41 of the user input means 4 on the basis of the accommodation reservation information stored in the storage unit 30.

The accommodation unit information display unit 334 displays attributes of the lockers 510 and 520 on the touch panel 41 of the user input means 4 on the basis of the attribute information stored in the storage unit 30. Here, the attributes of the lockers 510 and 520 are attributes for selecting the lockers 510 and 520. Specifically, the attributes of the lockers 510 and 520 can include, for example, features such as positions, sizes, and shapes of the lockers 510 and 520, as well as functions such as refrigeration, freezing, and temperature and humidity adjustment.

The accommodation unit selection unit 335 allows the user of the room 20 to select the lockers 510 and 520 displayed on the touch panel 41 of the user input means 4 via the user input means 4.

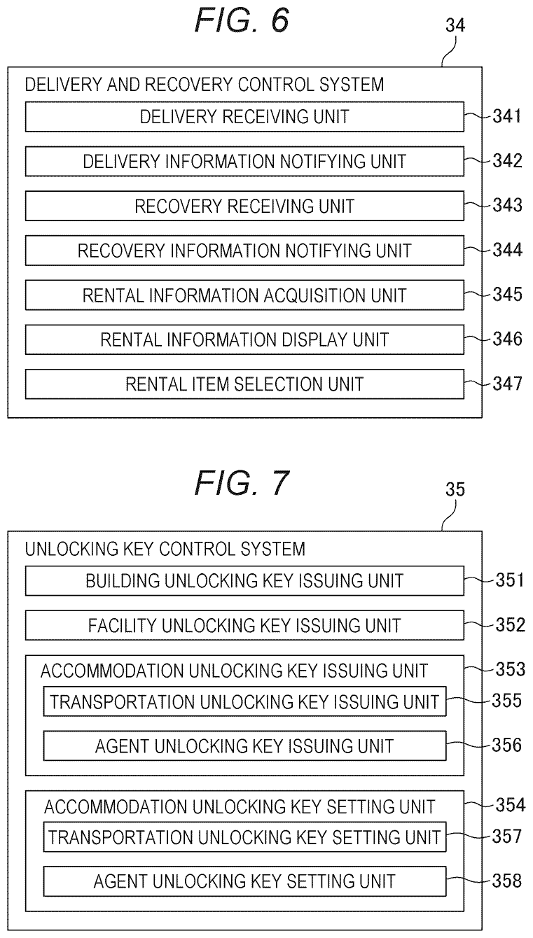

FIG. 6 is a block diagram illustrating functions of the delivery and recovery control system.

The delivery and recovery control system 34 is a control system for receiving delivery of the objects to the lockers 510 and 520 to cause the delivery agent to deliver the object, and receiving recovery of the objects in the lockers 510 and 520 to cause the delivery agent to recover the object. As illustrated in FIG. 6, the delivery and recovery control system 34 includes a delivery receiving unit 341, a delivery information notifying unit 342, a recovery receiving unit 343, a recovery information notifying unit 344, a rental information acquisition unit 345, and a rental information display unit 346, and a rental item selection unit 347.

The delivery receiving unit 341 receives the delivery of the objects to the lockers 510 and 520 for which the reservation is received by the accommodation reservation receiving unit 331.

The delivery information notifying unit 342 notifies the delivery agent of the accommodation reservation information on the lockers 510 and 520 at a delivery destination stored in the storage unit 30, and notifies the delivery agent of an accommodation unlocking key issued by the unlocking key control system 35. In other words, in the present embodiment, the delivery information notifying unit 342 functions as an accommodation reservation information notifying unit for notifying the delivery agent of the accommodation reservation information stored in the storage unit 30. The accommodation unlocking key will be described later in detail.

Further, in the present embodiment, the delivery receiving unit 341 is configured to receive collection information on collection of the object, and the delivery information notifying unit 342 is configured to notify the delivery agent of the collection information.

Note that the delivery receiving unit 341 may be configured not to receive the collection information on the collection of the object, and the delivery information notifying unit 342 may be configured not to notify the delivery agent of the collection information.

The recovery receiving unit 343 receives recovery of the objects in the lockers 510 and 520 for which the reservation is received by the accommodation reservation receiving unit 331.

The recovery information notifying unit 344 notifies the delivery agent of the accommodation reservation information on the lockers 510 and 520 of the recovery destination stored in the storage unit 30, and notifies the delivery agent of the accommodation unlocking key issued by the unlocking key control system 35. In other words, in the present embodiment, the recovery information notifying unit 344 functions as the accommodation reservation information notifying unit for notifying the delivery agent of the accommodation reservation information stored in the storage unit 30. The accommodation unlocking key will be described later in detail.

Further, in the present embodiment, the recovery receiving unit 343 is configured to receive shipping information on shipping of the object, and the recovery information notifying unit 344 is configured to notify the delivery agent of the shipping information.

Note that the recovery receiving unit 343 may be configured not to receive the shipping information on the shipping of the object, and the recovery information notifying unit 344 may be configured not to notify the delivery agent of the shipping information.

The rental information acquisition unit 345 acquires rental information on rental items that can be rented at the reservation date and time of the lockers 510 and 520 on the basis of the accommodation reservation information stored in the storage unit 30 and stores the rental information in the storage unit 30.

The rental information display unit 346 displays the rental items that can be rented at the reservation date and time of the lockers 510 and 520 on the touch panel 41 of the user input means 4 on the basis of the rental information stored in the storage unit 30.

The rental item selection unit 347 allows the user of the room 20 to select the rental item displayed on the touch panel 41 of the user input means 4 via the user input means 4.

Note that in the present embodiment, when the user of the room 20 is allowed to select the rental item via the user input means 4, the object is the rental item.

FIG. 7 is a block diagram illustrating functions of the unlocking key control system.

The unlocking key control system 35 is a control system for issuing various unlocking keys of a building unlocking key for unlocking the building-side locking device 22 of the building 2, a facility unlocking key for unlocking the facility-side locking device 202 of the room 20, and the accommodation unlocking key for unlocking the accommodation-side locking devices 50 of the lockers 510 and 520, and for enabling or disabling the various unlocking keys. As illustrated in FIG. 7, the unlocking key control system 35 includes a building unlocking key issuing unit 351, a facility unlocking key issuing unit 352, an accommodation unlocking key issuing unit 353, and an accommodation unlocking key setting unit 354.

The building unlocking key issuing unit 351 issues the building unlocking key for unlocking the building-side locking device 22 of the building 2 to the user of the room 20 and the transportation robot 6 on the basis of the facility reservation information stored in the storage unit 30.

The facility unlocking key issuing unit 352 issues the facility unlocking key for unlocking the facility-side locking device 202 of the room 20 to the user of the room 20 and the transportation robot 6 on the basis of the facility reservation information stored in the storage unit 30.

Specifically, the building unlocking key issuing unit 351 and the facility unlocking key issuing unit 352 issue the building unlocking key and the facility unlocking key, and transmit the building unlocking key and the facility unlocking key to the user input means 4 and the transportation robot 6 via the Internet 7.

The user of the room 20 and the transportation robot 6 can unlock the building-side locking device 22 of the building 2 with the building unlocking key, and unlock the facility-side locking device 202 of the room 20 with the facility unlocking key by receiving the building unlocking key and the facility unlocking key.

Here, the building unlocking key and the facility unlocking key may be a common key or different keys. When the building unlocking key and the facility unlocking key are the common key, the user of the room 20 can unlock both the building-side locking device 22 of the building 2 and the facility-side locking device 202 of the room 20 with the common key, and can improve convenience for the user of the room 20.

Further, as the unlocking key, for example, a personal identification number, an optical code such as a bar code and a QR code (registered trademark), or the like can be employed.

Note that in the present embodiment, the personal identification number, the optical code such as the bar code and the QR code (registered trademark), or the like is employed as the unlocking key, but as the unlocking key issued to the user of the room 20, for example, biometric authentication such as face authentication, fingerprint authentication, or retinal authentication may be employed, and any unlocking key may be employed as long as it can unlock the building-side locking device 22 of the building 2 and the facility-side locking device 202 of the room 20.

The accommodation unlocking key issuing unit 353 issues the accommodation unlocking key for unlocking the accommodation-side locking devices 50 of the lockers 510 and 520 which are the delivery destinations for which the delivery is received by the delivery receiving unit 341 or the recovery destinations for which the recovery is received by the recovery receiving unit 343. The accommodation unlocking key issuing unit 353 includes a transportation unlocking key issuing unit 355 and an agent unlocking key issuing unit 356.

The transportation unlocking key issuing unit 355 issues the transportation unlocking key for unlocking the accommodation-side locking devices 50 of the lockers 510 and 520 for which the reservation is received by the accommodation reservation receiving unit 331 to the transportation robot 6.

The agent unlocking key issuing unit 356 unlocks the accommodation-side locking devices 50 of the lockers 510 and 520 for which the reservation is received by the accommodation reservation receiving unit 331, and issues the agent unlocking key different from the transportation unlocking key to the delivery agent.

Specifically, the transportation unlocking key issuing unit 355 issues the transportation unlocking key and transmits the transportation unlocking key to the transportation robot 6 via the Internet 7.

The transportation robot 6 can unlock the accommodation-side locking devices 50 of the lockers 510 and 520 with the transportation unlocking key by receiving the transportation unlocking key.

Further, the agent unlocking key issuing unit 356 issues the agent unlocking key and transmits the agent unlocking key to the delivery agent via the Internet 7.

The delivery agent can unlock the accommodation-side locking devices 50 of the lockers 510 and 520 with the agent unlocking key by receiving the agent unlocking key.

Note that in the present embodiment, the lockers 510 and 520 respectively includes the doors 511 and 521, and a storage-side locking devices 50 as the locking devices of the accommodation unit for locking and unlocking the doors 511 and 521, and both the transportation unlocking key and the agent unlocking key can unlock the accommodation-side locking device 50.

In contrast, the accommodation unit may include a door for transportation (for the user) and a door for the agent different from the door for transportation, the transportation unlocking key may be able to unlock only the door for transportation, and the agent unlocking key may be able to unlock only the door for the agent.

The accommodation unlocking key setting unit 354 enables or disables the unlocking key for unlocking the accommodation-side locking devices 50 of the locker 510 and 520 for which the reservation is received by the accommodation reservation receiving unit 331. The accommodation unlocking key setting unit 354 includes a transportation unlocking key setting unit 357 and an agent unlocking key setting unit 358.

The transportation unlocking key setting unit 357 enables or disables the transportation unlocking key on the basis of a predetermined condition.

The agent unlocking key setting unit 358 enables or disables the agent unlocking key on the basis of a predetermined condition.

Specifically, the agent unlocking key setting unit 358 determines a specific time period to enable the agent unlocking key on the basis of the accommodation reservation information stored in storage unit 30, and enables the agent unlocking key at a start of the specific time period and disables the agent unlocking key at an end of the specific time period. Here, the specific time period can be determined to be, for example, from slightly before (for example, 10 minutes before) the usage start time of the lockers 510 and 520 to slightly after (for example, 10 minutes after) the usage end time.

Further, the agent unlocking key setting unit 358 disables the agent unlocking key without waiting for the end of the specific time period after the agent unlocking key is used.

Note that the agent unlocking key setting unit 358 may disable the agent unlocking key at the end of the specific time period regardless of whether or not the agent unlocking key is used.

Then, when the agent unlocking key issuing unit 356 issues the agent unlocking key, the transportation unlocking key setting unit 357 disables the agent unlocking key, and then enables the transportation unlocking key. Further, the transportation unlocking key setting unit 357 disables the transportation unlocking key after the transportation unlocking key is used.

Further, when the agent unlocking key issuing unit 356 does not issue the agent unlocking key, the transportation unlocking key setting unit 357 determines the specific time period to enable the transportation unlocking key on the basis of the accommodation reservation information stored in the storage unit 30, and enables the transportation unlocking key at the start of the specific time period, and disables the transportation unlocking key at the end of the specific time period. Here, the specific time period can be determined to be, for example, from slightly before (for example, 10 minutes before) the usage start time of the lockers 510 and 520 to slightly after (for example, 10 minutes after) the usage end time.

Note that the transportation unlocking key setting unit 357 may enable or disable the transportation unlocking key on the basis of conditions different from conditions described above, for example, may enable the transportation unlocking key at a start of a specified time specified by the user of the room 20, and disable the transportation unlocking key at an end of the specified time. In short, the transportation unlocking key setting unit 357 enables or disables the transportation unlocking key on the basis of the predetermined condition.

Further, the agent unlocking key setting unit 358 may enable or disable the agent unlocking key on the basis of conditions different from the conditions described above, for example, may enable the agent unlocking key at the start of the specified time specified by the user of the room 20, and disable the agent unlocking key at the end of the specified time. In short, the agent unlocking key setting unit enables or disables the agent unlocking key on the basis of the predetermined condition.

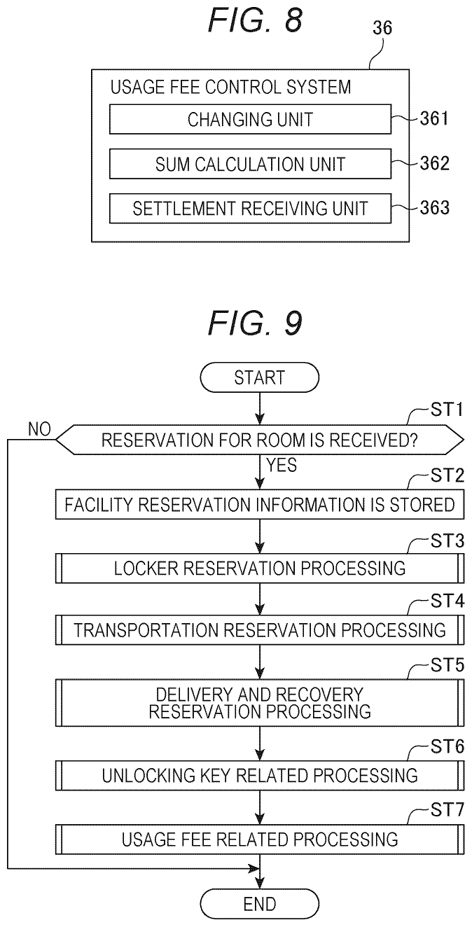

FIG. 8 is a block diagram illustrating functions of the usage fee control system.

The usage fee control system 36 is a control system for changing usage fees for the lockers 510 and 520 and usage periods of the lockers 510 and 520, and settling the usage fees for the lockers 510 and 520 and the usage fee for the room 20. As illustrated in FIG. 8, the usage fee control system 36 includes a changing unit 361, a sum calculation unit 362, and a settlement receiving unit 363.

Note that in the present embodiment, the usage fee control system 36 has a function of settling the usage fees for the lockers 510 and 520 and the usage fee for the room 20, but may have a function of settling other usage fees such as delivery, collection, recovery, shipping, and rental. In this case, the management server 3 may have a function of paying a price to the delivery agent, a rental agent, and the like.

The changing unit 361 changes at least one of the usage fees for the lockers 510 and 520 and the usage periods of the lockers 510 and 520 on the basis of a predetermined condition. In the present embodiment, the changing unit 361 employs a condition related to a period such as off-season and busy season as the predetermined condition, and changes the usage periods of the lockers 510 and 520 to be lengthened during the off-season and to be shortened during the busy season. In addition, in the present embodiment, the changing unit 361 employs a condition related to attributes of the user based on a usage situation of the user as the predetermined condition, and changes the usage fees for the lockers 510 and 520 to be discounted to VIP members.

In the present embodiment, the changing unit 361 changes both the usage fees for the lockers 510 and 520 and the usage periods of the lockers 510 and 520, but may change only one of them, or need not change both of them. Further, the changing unit 361 may change not only the usage fees for the lockers 510 and 520 and the usage periods of the lockers 510 and 520 but also the usage fee for the room 20 and the usage period of the room 20.

The sum calculation unit 362 calculates a sum of the usage fees for the lockers 510 and 520 and the usage fee for the room 20.

The settlement receiving unit 363 receives settlement for the sum of the usage fees calculated by the sum calculation unit 362. In the present embodiment, the settlement receiving unit 363 displays the sum of the usage fees calculated by the sum calculation unit 362 on the touch panel 41 of the user input means 4. Further, the settlement receiving unit 363 receives the settlement for the sum of the usage fees calculated by the sum calculation unit 362 via the user input means 4.

Note that in the present embodiment, the settlement receiving unit 363 receives the settlement by electronic money or credit card. On the other hand, the settlement receiving unit 363 may receive the settlement of the sum of the usage fees calculated by the sum calculation unit 362 by displaying a transfer destination on the touch panel 41 of the user input means 4. Further, the usage fees for the lockers 510 and 520 and the usage fee for the room 20 may be separately settled.

FIG. 9 is a flowchart illustrating an operation of the on-demand rental facility management system.

As described above, the user can refer to the room 20 desired to be used and the accommodation means 5, and reserve the room 20 and the accommodation means 5 by being connected to the management server 3 via the user input means 4.

When reserving the room 20 and the accommodation means 5, as illustrated in FIG. 9, the management server 3 repeatedly performs various processing in steps ST1 to ST7 at predetermined time intervals according to the predetermined program stored in the memory.

The facility reservation receiving unit 31 determines whether the reservation for the room 20 is received via the user input means 4 in step ST1.

If the facility reservation receiving unit 31 determines that the reservation for the room 20 is not received, it ends loop processing without performing the processing from step ST2 onward.

On the other hand, if the facility reservation receiving unit 31 determines that the reservation for the room 20 is received, in step ST2, it stores the facility reservation information on the user and the reservation date and time (usage start time and usage end time) of the room 20 in the storage unit 30.

After performing the processing in step ST2, the accommodation reservation control system 33 performs locker reservation processing in step ST3.

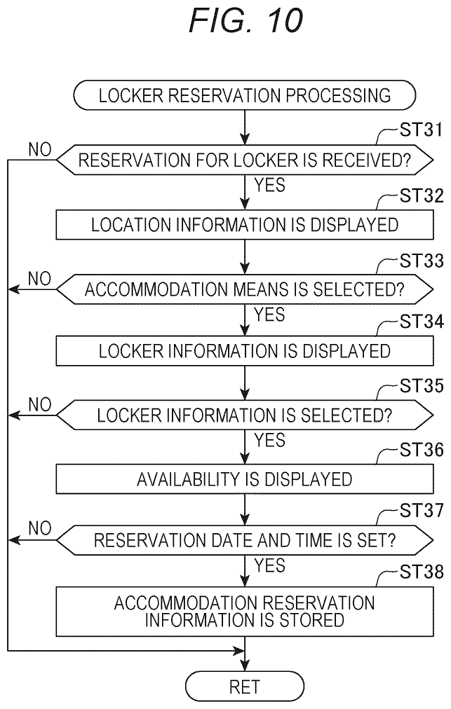

FIG. 10 is a flowchart illustrating an operation of the locker reservation processing.

In the locker reservation processing, as illustrated in FIG. 10, the accommodation reservation control system 33 performs various processing in steps ST31 to ST38.

The accommodation reservation receiving unit 331 determines whether the reservation for the lockers 510 and 520 is received via the user input means 4 in step ST31.

Note that the accommodation reservation receiving unit 331 displays a screen (not illustrated) for asking the user of the room 20 whether to reserve the lockers 510 and 520 on the touch panel 41 of the user input means 4, and determines whether the reservation for the lockers 510 and 520 is received by receiving an answer as to whether to reserve the lockers 510 and 520 via the user input means 4.

If it is determined in step ST31 that the reservation for the lockers 510 and 520 is not received via the user input means 4, the management server 3 ends the locker reservation processing without performing the processing from step ST32 onward.

On the other hand, if it is determined in step ST31 that the reservation for the lockers 510 and 520 is received via the user input means 4, in step ST32, the location information display unit 332 displays the placement locations of the first accommodation means 51 and the second accommodation means 52 on the touch panel 41 of the user input means 4 on the basis of the location information stored in the storage unit 30.

Here, the storage unit 30 stores in advance the location information on the placement locations of the first accommodation means 51 and the second accommodation means 52.

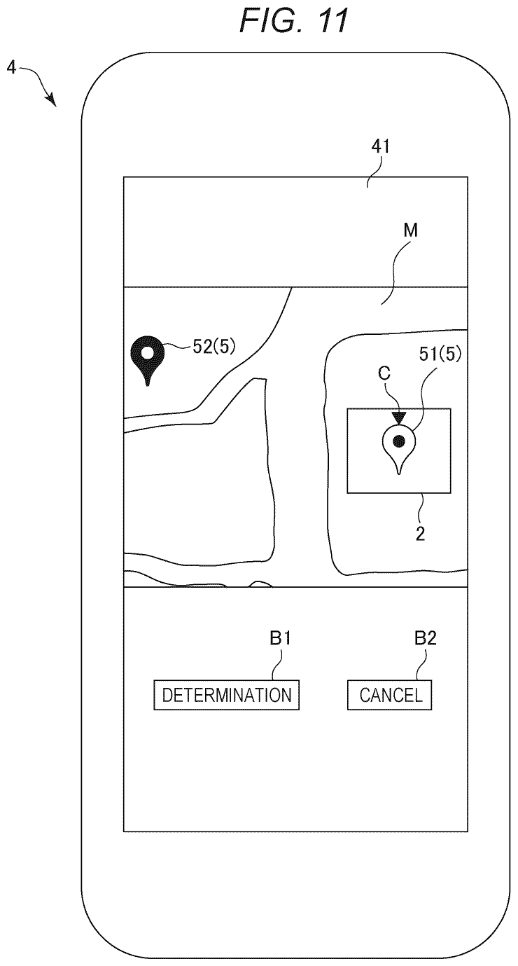

FIG. 11 is a diagram illustrating the display unit of the user input means displaying the placement locations of the first accommodation means and the second accommodation means.

As illustrated in FIG. 11, the location information display unit 332 displays a map M on the touch panel 41 of the user input means 4, and displays the placement locations of the first accommodation means 51 and the second accommodation means 52 with black and white markers on the map M. Further, the location information display unit 332 displays a determination button B1 for receiving selection of the accommodation means 5 and a cancel button B2 for receiving cancellation of reservation for the accommodation means 5 on the touch panel 41 of the user input means 4.

Here, as described above, the first accommodation means 51 is disposed inside the building 2. Further, the second accommodation means 52 is disposed not near the building 2 but in the premises of the nearest station to the building 2.

Further, in the present embodiment, the location information display unit 332 grasps the availability of the lockers 510 and 520 on the basis of the accommodation reservation information stored in the storage unit 30, and displays the white marker on the map M when the lockers 510 and 520 are available at the reservation date and time of the room 20, and displays the black marker on the map M when the lockers 510 and 520 are not available at the reservation date and time of the room 20.

In the present embodiment, since the first accommodation means 51 is displayed on the map M with the white marker, it is indicated that the lockers 510 and 520 are available at the reservation date and time of the room 20. Further, since the second accommodation means 52 is displayed on the map M with the black marker, it is indicated that the lockers 510 and 520 are not available at the reservation date and time of the room 20.

Note that the marker may be of any color or shape, and the availability of the lockers 510 and 520 may not be displayed. In short, it is sufficient that the location information display unit 332 can display the placement locations of the first accommodation means 51 and the second accommodation means 52 on the touch panel 41 of the user input means 4.

When the user of the room 20 selects the accommodation means 5, the user of the room 20 can select the accommodation means 5 by selecting one of the first accommodation means 51 and the second accommodation means 52 and pressing the determination button B1, on the basis of the black and white markers indicating the placement locations of the first accommodation means 51 and the second accommodation means 52 displayed on the map M. Here, when one of the first accommodation means 51 and the second accommodation means 52 is selected, the location information display unit 332 displays a cursor C indicating that the accommodation means 5 is being selected on the map M.

Note that in an example of FIG. 11, the user of the room 20 selects the first accommodation means 51 indicated by the white marker, but may select the second accommodation means 52 indicated by the black marker. This is because the color of the marker merely indicates whether the lockers 510 and 520 are available at the reservation date and time of the room 20.

On the other hand, when the user of the room 20 does not select the accommodation means 5, the user can cancel the reservation for the accommodation means 5 by pressing the cancel button B2.

As illustrated in FIG. 10, the management server 3 determines whether the selection of the accommodation means 5 is received in step ST33.

If it is determined in step ST33 that the selection of the accommodation means 5 is not received, in other words, if the user of the room 20 presses the cancel button B2, the management server 3 ends the locker reservation processing without performing the processing from step ST34 onward.

On the other hand, if it is determined in step ST33 that the selection of the accommodation means 5 is received, in other words, if the user of the room 20 selects one of the first accommodation means 51 and the second accommodation means 52 and then presses the determination button B1, in step ST34, the accommodation unit information display unit 334 displays locker information on the touch panel 41 of the user input means 4. Specifically, the accommodation unit information display unit 334 displays the attributes of the lockers 510 and 520 as the locker information for each of the lockers 510 and 520 on the touch panel 41 of the user input means 4, on the basis of the attribute information stored in the storage unit 30.

Here, the storage unit 30 stores in advance the attribute information on the attributes of the lockers 510 and 520 for selecting the lockers 510 and 520.

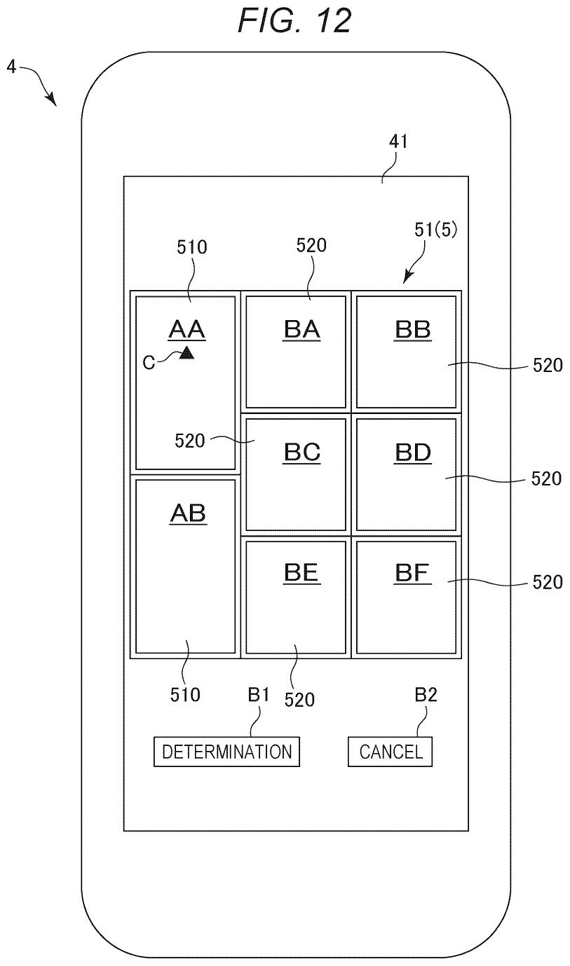

FIG. 12 is a diagram illustrating the display unit of the user input means displaying the attributes of the plurality of lockers in the first accommodation means.

As illustrated in FIG. 12, the accommodation unit information display unit 334 displays the positions, sizes, and shapes of the lockers 510 and 520 in the first accommodation means 51 as the attributes of the lockers 510 and 520 on the touch panel 41 of the user input means 4. Further, the accommodation unit information display unit 334 displays the determination button B1 for receiving selection of the lockers 510 and 520 and the cancel button B2 for receiving cancellation of the reservation for the lockers 510 and 520, on the touch panel 41 of the user input means 4.

Here, in an example of FIG. 12, two lockers 510 are large lockers arranged on the left side of the first accommodation means 51 when viewed from the front displayed on the touch panel 41 of the user input means 4 and formed in a rectangular shape. The accommodation unit information display unit 334 attaches the lockers 510 respectively with labels AA and AB. Further, the six lockers 520 are small lockers arranged on the right side of the first accommodation means 51 when viewed from the front displayed on the touch panel 41 of the user input means 4 and formed in a substantially square shape. The accommodation unit information display unit 334 attaches the lockers 520 respectively with labels BA to BF.

In this way, the accommodation unit information display unit 334 visually indicates the positions, sizes, and shapes of the lockers 510 and 520.

When the user of the room 20 selects the lockers 510 and 520, the user can select the lockers 510 and 520 by selecting one of the lockers 510 and 520 and pressing the determination button B1, on the basis of the attributes of the lockers 510 and 520 displayed on the touch panel 41 of the user input means 4. Here, when one of the lockers 510 and 520 is selected, the accommodation unit information display unit 334 displays a cursor C indicating that the lockers 510 and 520 are being selected on the touch panel 41 of the user input means 4.

Note that in the example of FIG. 12, the user of room 20 selects the locker 510 labeled AA, but the user may select other lockers 510 and 520 on the basis of the attributes of the lockers 510 and 520.

On the other hand, when the user of the room 20 does not select the lockers 510 and 520, the user can cancel the reservation for the lockers 510 and 520 by pressing the cancel button B2.

As illustrated in FIG. 10, the management server 3 determines whether the selection of the lockers 510 and 520 is received in step ST35.

If it is determined in step ST35 that the selection of the lockers 510 and 520 is note received, in other words, if the user of the room 20 presses the cancel button B2, the management server 3 ends the locker reservation processing without performing the processing from step ST36 onward.

On the other hand, if it is determined in step ST35 that the selection of the lockers 510 and 520 is received, in other words, if the user of room 20 selects one of the lockers 510 and 520 and then presses the determination button B1, in step ST36, the availability display unit 333 displays the availability of the lockers 510 and 520 on the touch panel 41 of the user input means 4 on the basis of the accommodation reservation information stored in the storage unit 30.

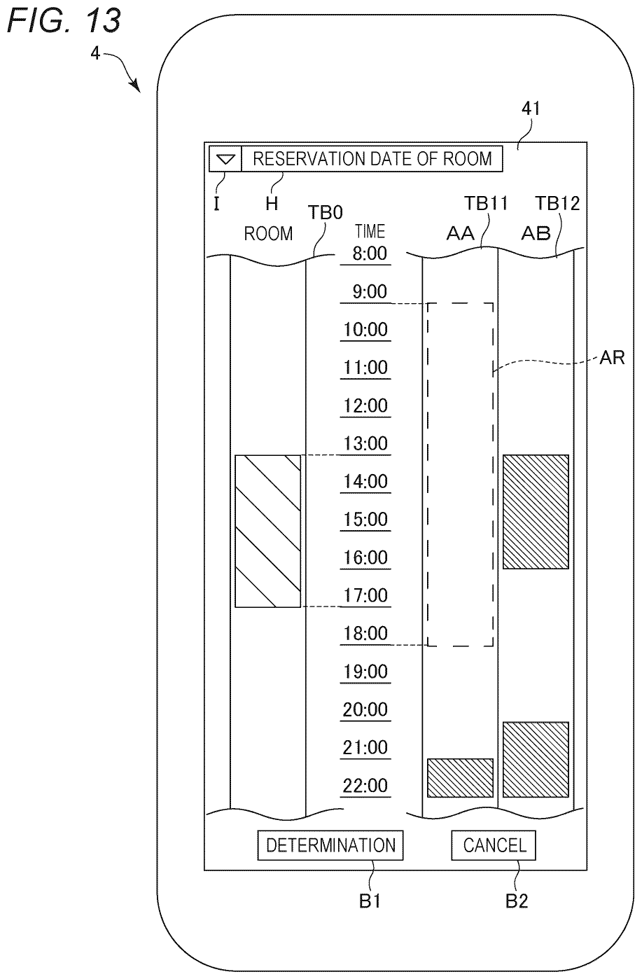

FIG. 13 is a diagram illustrating the display unit of the user input means displaying the availability of the locker.

As illustrated in FIG. 13, the availability display unit 333 displays the availability of the lockers 510 and 520 at the reservation date and time of the room 20 on the touch panel 41 of the user input means 4. In addition, the availability display unit 333 displays the determination button B1 for receiving setting of the reservation date and time of the lockers 510 and 520 and the cancel button B2 for receiving cancellation of the reservation for the lockers 510 and 520, on the touch panel 41 of the user input means 4.

Here, in an example of FIG. 13, the availability display unit 333 displays the reservation date of the room 20 in a date display section H disposed on the upper left of the touch panel 41 of the user input means 4. The date display section H includes a date selection section I disposed at the left end of the date display section H. The user of the room 20 can select a date different from the reservation date of the room 20 by pressing the date selection section I, and display the availability of the lockers 510 and 520 on that day on the touch panel 41 of the user input means 4.

Further, the availability display unit 333 displays the reservation time of the room 20 in a facility reservation time table TB0 disposed on the center left side of the touch panel 41 of the user input means 4, and displays the availability of the lockers 510 and 520 in availability tables TB11 and TB12 arranged on the center right side. Then, the availability display unit 333 displays the time corresponding to the tables TB0, TB11 and TB12 between the facility reservation time table TB0 and the availability tables TB11 and TB12.

The facility reservation time table TB0 is a timetable showing the reservation time of the room 20. The facility reservation time table TB0 shows the reservation time of the room 20 by a shaded area.

The availability table TB11 is a timetable showing the availability of the locker 510 labeled AA selected by the user of the room 20. The availability table TB12 is a timetable showing the availability of the locker 510 labeled AB having the same attributes as the locker 510 labeled AA. The availability tables TB11 and TB12 respectively display the availability of the lockers 510 by respectively displaying the reservation time of the lockers 510 by shaded areas.

In the present embodiment, the availability display unit 333 displays not only the availability table TB11 showing the availability of the locker 510 labeled AA selected by the user of the room 20, but also the availability table TB 12 showing the availability of the locker 510 labeled AB having the same attributes as the locker 510 labeled AA on the touch panel 41 of the user input means 4. According to this, the user of the room 20 can refer to not only the availability of the locker 510 labeled AA that the user has selected but also the availability of the locker 510 labeled AB having the same attributes as the locker 510 labeled AA.

Note that in the present embodiment, the availability display unit 333 displays both the availability table TB11 and the availability table TB 12 on the touch panel 41 of the user input means 4, but may display only the availability table TB11 on the touch panel 41 of the user input means 4, and may display an availability table showing availability of the other lockers 510 and 520 on the touch panel 41 of the user input means 4.

When the user of the room 20 sets the reservation date and time of the lockers 510 and 520, the user can set the reservation date and time of the lockers 510 and 520 by selecting the reservation date and time of the lockers 510 and 520 and pressing the determination button B1, on the basis of the availability tables TB11 and TB 12 displayed on the touch panel 41 of the user input means 4. Here, when the reservation date and time of the lockers 510 and 520 are selected, the availability display unit 333 displays a dashed line area AR indicating that the reservation date and time of the lockers 510 and 520 is being selected on the touch panel 41 of the user input means 4.

Note that in the example of FIG. 13, the user of room 20 selects a reservation date and time from 9:00 to 18:00 for the locker 510 labeled AA, but the user may select other reservation date and time, and may select the locker 510 labeled AB or another locker.

On the other hand, when the user of the room 20 does not set the reservation date and time of the lockers 510 and 520, the user can cancel the reservation for the lockers 510 and 520 by pressing the cancel button B2.

As illustrated in FIG. 10, in step ST37, the management server 3 determines whether the setting of the reservation date and time of the lockers 510 and 520 is received.

If it is determined in step ST37 that the setting of the reservation date and time of the lockers 510 and 520 is not received, in other words, if the user of the room 20 presses the cancel button B2, the management server 3 ends the locker reservation processing without performing the processing from step ST38 onward.

On the other hand, if it is determined in step ST37 that the setting of the reservation date and time of the lockers 510 and 520 is received, in other words, if the user of the room 20 selects the reservation date and time of the lockers 510 and 520 and then presses the determination button B1, in step ST38, the accommodation reservation receiving unit 331 associates the accommodation reservation information on the user and the reservation date and time (usage start time and usage end time) of the lockers 510 and 520 with the facility reservation information and stores the accommodation reservation information in the storage unit 30. Thereafter, the management server 3 ends the locker reservation processing.

Returning to description of FIG. 9, the processing from step ST4 onward will be described.

After performing the locker reservation processing in step ST3, as illustrated in FIG. 9, the item transportation control system 32 performs transportation reservation processing in step ST4.

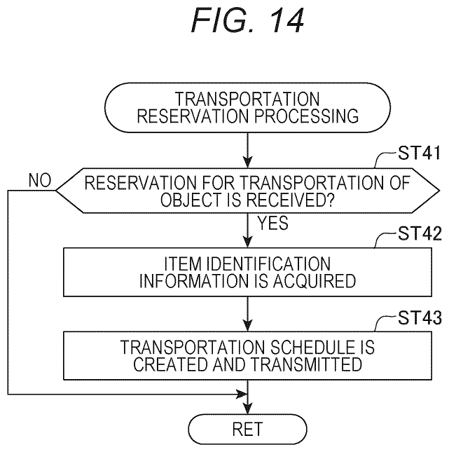

FIG. 14 is a flowchart illustrating an operation of the transportation reservation processing.

In the transportation reservation processing, as illustrated in FIG. 14, the item transportation control system 32 performs various processing in steps ST41 to ST43.

In step ST41, the transportation receiving unit 321 determines whether the transportation of the object, which is the item related to the user of the room 20, is received via the user input means 4.

Note that the transportation reception unit 321 displays a screen (not illustrated) for asking the user of the room 20 whether to reserve the transportation of the object on the touch panel 41 of the user input means 4, and determines whether the transportation of the object is received by receiving an answer as to whether to reserve the transportation of the object via the user input means 4.

If it is determined in step ST41 that the transportation of the object is not received via the user input means 4, the management server 3 ends the transportation reservation processing without performing the processing from step ST42 onward.

n the other hand, if it is determined in step ST41 that the transportation of the object is received via the user input means 4, in step ST42, the item identification information acquisition unit 322 acquires the item identification information for identifying the object stored in the lockers 510 and 520. Specifically, the item identification information acquisition unit 322 acquires the accommodation reservation information stored in the storage unit 30 as the item identification information.

Note that in the present embodiment, the item identification information acquisition unit 322 acquires the accommodation reservation information stored in the storage unit 30 as the item identification information. However, when the accommodation reservation information is not stored in the storage unit, for example, when the user of the on-demand rental facility stores the object in an accommodation unit prepared separately from the reservation for the on-demand rental facility, the item identification information acquisition unit may be notified of information for identifying the accommodation unit that accommodates the object by the user of the on-demand rental facility, the delivery agent, or the like and acquire this information as the item identification information.

After performing the processing in step ST42, in step ST43, the transportation control unit 323 creates a transportation schedule for causing the transportation robot 6 to transport the object from the lockers 510 and 520 to the room 20 at the reservation date and time of the room 20 on the basis of the facility reservation information stored in the storage unit 30 and the item identification information (accommodation reservation information) acquired by the item identification information acquisition unit 322, stores the transportation schedule in the storage unit 30, and transmits the transportation schedule to the transportation robot 6. Here, the transportation control unit 323 creates the transportation schedule so that the transport robot 6 transports the object from the lockers 510 and 520 to the room 20 a little before (in the present embodiment, 10 minutes before) the usage start time of the room 20. Thereafter, the management server 3 ends the transportation reservation processing. Note that if the reservation for the lockers 510 and 520 is not received at a time when the transportation robot 6 transports the object from the lockers 510 and 520 to the room 20, the transportation control unit 323 is configured to issue a warning to the user of the room 20 via the touch panel 41 of the user input means 4.

Further, the transportation control unit 323 creates a transportation schedule for causing the transportation robot 6 to transport the object from the room 20 to the lockers 510 and 520 after the reservation date and time of the room 20 passes on the basis of the facility reservation information stored in the storage unit 30 and the item identification information acquired by the item identification information acquisition unit 322, stores the transportation schedule in the storage unit 30, and transmits the transportation schedule to the transportation robot 6. Here, the transportation control unit 323 creates the transportation schedule so that the transport robot 6 transports the object from the room 20 to the lockers 510 and 520 a little after (in the present embodiment, 10 minutes after) the usage end time of the room 20. Note that if the reservation for the lockers 510 and 520 is not received at a time when the transportation robot 6 transports the object from the room 20 to the lockers 510 and 520, the transportation control unit 323 is configured to issue the warning to the user of the room 20 via the touch panel 41 of the user input means 4.

The transportation robot 6 transports the object from the lockers 510 and 520 to the room 20 at the reservation date and time of the room 20, and transports the object from the room 20 to the lockers 510 and 520 after the reservation date and time of the room 20 passes, on the basis of the transportation schedule transmitted by the transportation control unit 323.

Returning to the description of FIG. 9, the processing from step ST5 onward will be described.

After performing the transportation reservation processing in step ST4, as illustrated in FIG. 9, the delivery and recovery control system 34 and the unlocking key control system 35 perform delivery and recovery reservation processing in step ST5.

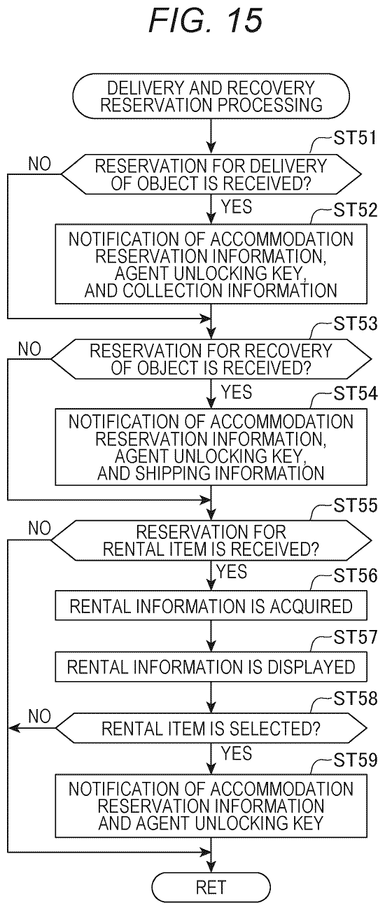

FIG. 15 is a flowchart illustrating an operation of the delivery and recovery reservation processing.

In the delivery and recovery reservation processing, the delivery and recovery control system 34 and the unlocking key control system 35 perform various processing in steps ST51 to ST59 as illustrated in FIG. 15.

The delivery receiving unit 341 determines in step ST51 whether the delivery of the object to the lockers 510 and 520 is received via the user input means 4.

Note that the delivery receiving unit 341 displays a screen (not illustrated) for asking the user of the room 20 whether to reserve the delivery of the object to the lockers 510 and 520 on the touch panel 41 of the user input means 4, and determines whether the delivery of the object to the lockers 510 and 520 is received by receiving an answer as to whether to reserve the delivery of the object to the lockers 510 and 520 via the user input means 4.

Here, if it is determined in step ST51 that the delivery of the object to the lockers 510 and 520 is received via the user input means 4, the delivery receiving unit 341 further determines in step ST51 whether the collection of the object is received via the user input means 4.

Note that the delivery receiving unit 341 further displays a screen (not illustrated) for asking the user of the room 20 whether to reserve the collection of the object on the touch panel 41 of the user input means 4, and determines whether the collection of the object is received by receiving an answer as to whether to reserve the collection of the object via the user input means 4.

At this time, the delivery receiving unit 341 receives the collection information on the collection of the object (for example, information on a location (such as home of the user of the room 20) where the object is to be collected, and information on a time period when the object is to be collected), and stores the collection information in the storage unit 30.

Note that the delivery receiving unit 341 may receive, as the collection information, information on carry-in of the object to the delivery agent instead of the information on the location where the object is to be collected. In this case, the management server 3 may notify the user of deadline for the carry-in to the delivery agent. In addition, the delivery receiving unit 341 may receive, as the collection information, information on another accommodation means different from the accommodation means 5 as the information on the location where the object is to be collected. In this case, the management server 3 may be able to issue an unlocking key for another accommodation means to the delivery agent and notify the delivery agent of the unlocking key.

When it is determined in step ST51 that the delivery of the object to the lockers 510 and 520 is not received via the user input means 4, the management server 3 performs the processing from step ST53 onward.

On the other hand, when it is determined in step ST51 that the delivery of the object to the lockers 510 and 520 is received via the user input means 4, in step ST52, the agent unlocking key issuing unit 356 issues the agent unlocking key for unlocking the accommodation-side locking devices 50 of the lockers 510 and 520 for which the reservation is received by the accommodation reservation receiving unit 331 to the delivery agent. Further, in step ST52, the delivery information notifying unit 342 notifies the delivery agent of the accommodation reservation information on the lockers 510 and 520 at the delivery destination stored in the storage unit 30, and notifies the delivery agent of the agent unlocking key issued by the agent unlocking key issuing unit 356.

Further, when it is determined in step ST51 that the collection of the object is received via the user input means 4, in step ST52, the delivery information notifying unit 342 transmits the collection information stored in the storage section 30 to the delivery agent.

Note that the accommodation reservation information, the agent unlocking key, and the collection information are transmitted to the delivery agent via the Internet 7. Here, the delivery agent may be, for example, a delivery agent having destination information stored in the storage unit 30 in advance, or a delivery agent whose destination information is input by the user of the room 20.

After performing the processing in step ST52, or when it is determined in step ST51 that the delivery of the object to the lockers 510 and 520 is not received via the user input means 4, in step ST53, the recovery receiving unit 343 determines whether the recovery of the objects in the lockers 510 and 520 is received via the user input means 4.

Note that the recovery receiving unit 343 displays a screen (not illustrated) for asking the user of the room 20 whether to reserve the recovery of the objects in the lockers 510 and 520 on the touch panel 41 of the user input means 4, and determines whether the recovery of the objects in the lockers 510 and 520 is received by receiving an answer as to whether to reserve the recovery of the objects in the lockers 510 and 520 via the user input means 4.

Here, if it is determined in step ST53 that the recovery of the objects in the lockers 510 and 520 is received via the user input means 4, in step ST53, the recovery receiving unit 343 further determines whether the shipping of the object is received via the user input means 4.

Note that the recovery receiving unit 343 further displays a screen (not illustrated) for asking the user of the room 20 whether to reserve the shipping of the object on the touch panel 41 of the user input means 4, and determines whether the shipping of the object is received by receiving an answer as to whether to reserve the shipping of the object via the user input means 4.

At this time, the recovery receiving unit 343 receives the shipping information on the shipping of the object (for example, information on a location (such as home of the user of the room 20) from which the object is to be shipped, and information on a time period when the object is to be shipped), and stores the shipping information in the storage unit 30.

Note that the recovery receiving unit 343 may receive, as the shipping information, information on pick-up of the object by the delivery agent instead of the information on the location from which the object is to be shipped. In this case, the management server 3 may notify the user of deadline for the pick-up by the delivery agent. In addition, the recovery receiving unit 343 may receive, as the shipping information, information on another accommodation means different from the accommodation means 5 as the information on the location from which the object is to be shipped. In this case, the management server 3 may be able to issue an unlocking key for another accommodation means to the delivery agent and notify the delivery agent of the unlocking key.

If it is determined in step ST53 that the recovery of the objects in the lockers 510 and 520 is not received via the user input means 4, the management server 3 performs the processing from step ST55 onward.

On the other hand, if it is determined in step ST53 that the recovery of the objects in the lockers 510 and 520 is received via the user input means 4, in step ST54, the agent unlocking key issuing unit 356 issues the agent unlocking key for unlocking the accommodation-side locking devices 50 of the lockers 510 and 520 for which the reservation is received by the accommodation reservation receiving unit 331 to the delivery agent. Further, in step ST54, the recovery information notifying unit 344 notifies the delivery agent of the accommodation reservation information on the lockers 510 and 520 of the recovery destination stored in storage unit 30, and notifies the delivery agent of the agent unlocking key issued by the agent unlocking key issuing unit 356.

Further, if it is determined in step ST53 that the shipping of the object is received via the user input means 4, the recovery information notifying unit 344 notifies, in step ST54, the delivery agent of the shipping information stored in the storage unit 30.

Note that the accommodation reservation information, the agent unlocking key, and the shipping information are transmitted to the delivery agent via the Internet 7. Here, the delivery agent may be, for example, the delivery agent having the destination information stored in the storage unit 30 in advance, or the delivery agent whose destination information is input by the user of the room 20.

After performing the processing in step ST54, or when it is determined in step ST53 that the recovery of the objects in the lockers 510 and 520 is not received via the user input means 4, in step ST55, the management server 3 determines whether reservation for the rental item is received via the user input means 4.

Note that the management server 3 further displays a screen (not illustrated) for asking the user of the room 20 whether to reserve the rental item on the touch panel 41 of the user input means 4, and determines whether the reservation for the rental item is received by receiving an answer as to whether to reserve the rental item via the user input means 4.

If it is determined in step ST55 that the reservation for the rental item is not received via the user input means 4, the management server 3 ends the delivery and recovery reservation processing without performing the processing form step ST56 onward.

On the other hand, if it is determined in step ST55 that the reservation for the rental item is received via the user input means 4, in step ST56, the rental information acquisition unit 345 acquires the rental information on the rental items that can be rented at the reservation date and time of the lockers 510 and 520 on the basis of the accommodation reservation information stored in the storage unit 30, and stores the rental information in the storage unit 30. Specifically, the rental information acquisition unit 345 notifies the rental agent of the reservation date and time of the lockers 510 and 520 via the Internet 7, makes an inquiry about the rental items that can be rented, and acquires the rental information on the rental items that can be rented at the reservation date and time of the lockers 510 and 520 by receiving an answer to the inquiry from the rental agent.

After the rental information acquisition unit 345 acquires the rental information, in step ST57, the rental information display unit 346 displays the rental items that can be rented at the reservation date and time of the lockers 510 and 520 on the touch panel 41 of the user input means 4 on the basis of the rental information stored in the storage unit 30 (not illustrated). In addition, the rental information display unit 346 displays a determination button for receiving the reservation for the rental item and a cancel button for receiving cancellation of the reservation for the rental item on the touch panel 41 of the user input means 4 (not illustrated).

The user of room 20 can reserve the rental item by pressing the determination button. Further, the user of the room 20 can cancel the reservation for the rental item by pressing the cancel button.

Note that the rental item may be any item as long as it can be rented to the user of the room 20.

After the rental item is displayed on the touch panel 41 of the user input means 4 by the rental information display unit 346, the rental item selection unit 347 determines in step ST58 whether selection of the rental item is received.

If it is determined in step ST58 that the selection of the rental item is not received, in other words, if the user of room 20 presses the cancel button, the management server 3 ends the delivery and recovery reservation processing without performing the processing from step ST59 onward.

On the other hand, if it is determined in step ST58 that the selection of the rental item is received, in other words, if the user of the room 20 selects one of the rental items and then presses the determination button, in step ST59, the agent unlocking key issuing unit 356 issues the agent unlocking key for unlocking the accommodation-side locking devices 50 of the lockers 510 and 520 for which the reservation is received by the accommodation reservation receiving unit 331 to the rental agent. Further, in step ST59, the management server 3 notifies the rental agent of the accommodation reservation information on the lockers 510 and 520 for which the reservation is received by the accommodation reservation receiving unit 331, and notifies the rental agent of the agent unlocking key issued by the agent unlocking key issuing unit 356. Thereafter, the management server 3 ends the delivery and recovery reservation processing.

In this way, when the rental item is selected by the user of the room 20 via the user input means 4, the object is the rental item. In addition, in the present embodiment, when receiving the reservation for the rental item, the management server 3 functions as the delivery receiving unit, the delivery information notifying unit, the recovery receiving unit, and the recovery information notifying unit.

Note that the accommodation reservation information and the agent unlocking key are transmitted to the rental agent via the Internet 7.

Returning to the description of FIG. 9, the processing from step ST6 onward will be described.

After performing the delivery and recovery reservation processing in step ST5, as illustrated in FIG. 9, the unlocking key control system 35 performs unlocking key related processing in step ST6.

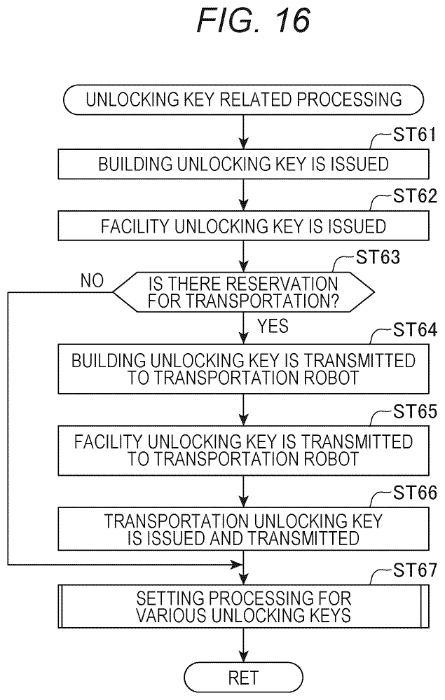

FIG. 16 is a flowchart illustrating an operation of the unlocking key related processing.

In the unlocking key related processing, the unlocking key control system 35 performs various processing in steps ST61 to ST67 as illustrated in FIG. 16.

In step ST61, the building unlocking key issuing unit 351 issues the building unlocking key for unlocking the building-side locking device 22 of the building 2 on the basis of the facility reservation information stored in the storage unit 30. In addition, the building unlocking key issuing unit 351 transmits the building unlocking key to the user input means 4 via the Internet 7.

After performing the processing in step ST61, in step ST62, the facility unlocking key issuing unit 352 issues the facility unlocking key for unlocking the facility-side locking device 202 of the room 20 on the basis of the facility reservation information stored in the storage unit 30. Further, the facility unlocking key issuing unit 352 transmits the facility unlocking key to the user input means 4 via the Internet 7.

After performing the processing in step ST62, in step ST63, the management server 3 determines whether there is a reservation for the transportation of the object on the basis of the transportation schedule stored in the storage unit 30.

If it is determined in step ST63 that there is no reservation for the transportation of the object, the management server 3 performs the processing from step ST67 onward.

On the other hand, if it is determined in step ST63 that there is the reservation for the transportation of the object, in step ST64, the building unlocking key issuing unit 351 transmits the building unlocking key to the transportation robot 6 via the Internet 7.

After performing the processing in step ST64, in step ST65, the facility unlocking key issuing unit 352 transmits the facility unlocking key to the transportation robot 6 via the Internet 7.

After performing the processing in step ST65, in step ST66, the transportation unlocking key issuing unit 355 issues the transportation unlocking key for unlocking the accommodation-side locking devices 50 of the lockers 510 and 520 for which the reservation is received by the accommodation reservation receiving unit 331 to the transportation robot 6. Further, the transportation unlocking key issuing unit 355 transmits the transportation unlocking key to the transportation robot 6 via the Internet 7.

Here, the transportation unlocking key and the agent unlocking key are different unlocking keys from each other for unlocking the accommodation-side locking devices 50 of the same lockers 510 and 520 for which the reservation is received by the accommodation reservation receiving unit 331.

Note that in the present embodiment, the transportation unlocking key and the agent unlocking key are different unlocking keys from each other, but they may be the same unlocking key. In this case, the accommodation unlocking key issuing unit 353 need not include the transportation unlocking key issuing unit 355 and the agent unlocking key issuing unit 356.

After performing the processing in step ST66, or when it is determined in step ST63 that there is no reservation for the transportation of the object, in step ST67, the management server 3 performs setting processing for the various unlocking keys. Thereafter, the management server 3 ends the unlocking key-related processing.

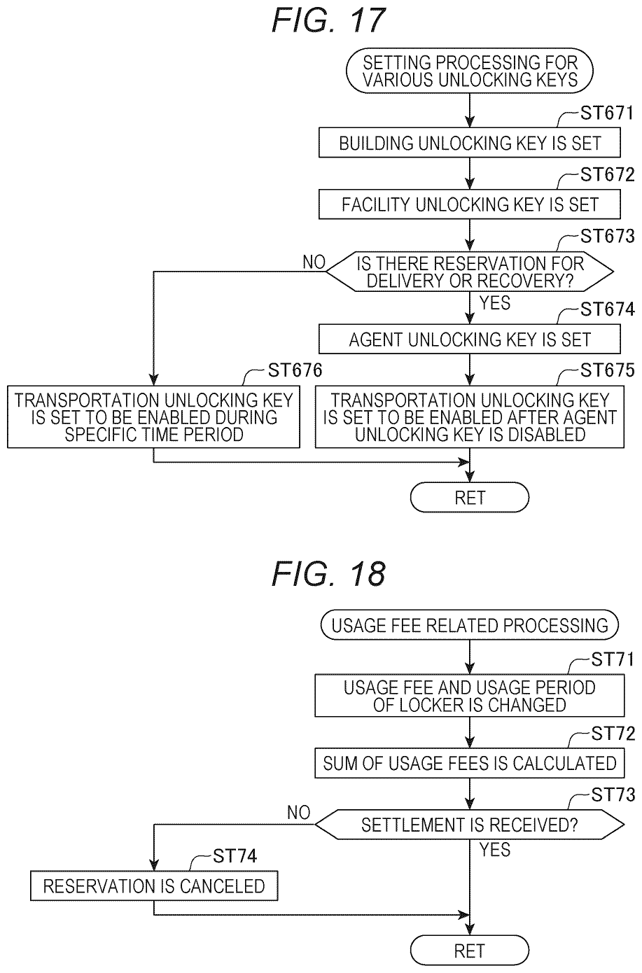

FIG. 17 is a flowchart illustrating an operation of the setting processing for the various unlocking keys.

In the setting processing of the various unlocking keys, as illustrated in FIG. 17, the unlocking key control system 35 performs various processing of steps ST671 to ST676.

In step ST671, the management server 3 creates an unlocking schedule for enabling or disabling the building unlocking key for unlocking the building-side locking device 22 of the building 2 on the basis of the facility reservation information stored in the storage unit 30, and stores the unlocking schedule in the storage unit 30.

After performing step ST671, in step ST672, the management server 3 creates an unlocking schedule for enabling or disabling the facility unlocking key for unlocking the facility-side locking device 202 of the room 20 on the basis of the facility reservation information stored in the storage unit 30, and stores the unlocking schedule in the storage unit 30.

Note that the management server 3 enables or disables the building unlocking key and the facility unlocking key on the basis of the unlocking schedule stored in the storage unit 30.

After performing step ST672, in step ST673, the management server 3 determines whether there is a reservation for delivery or a reservation for recovery. Specifically, if the management server 3 issues the agent unlocking key in any of the above-described steps ST52, ST54, and ST59, it determines that there is the reservation for delivery or the reservation for recovery, and if the management server 3 does not issue the agent unlocking key, it determines that there is no reservation for delivery or recovery.

If it is determined in step ST673 that there is the reservation for delivery or the reservation for recovery, in step ST674, the agent unlocking key setting unit 358 creates the unlocking schedule for enabling or disabling the agent unlocking key on the basis of a predetermined condition, and stores the unlocking schedule in the storage unit 30.

Specifically, the agent unlocking key setting unit 358 determines a specific time period to enable the agent unlocking key on the basis of the accommodation reservation information stored in storage unit 30, creates the unlocking schedule for enabling the agent unlocking key at the start of the specific time period and disabling the agent unlocking key at the end of the specific time period, and stores the unlocking schedule in the storage unit 30. Here, the specific time period can be determined to be, for example, from slightly before (for example, 10 minutes before) the usage start time of the lockers 510 and 520 to slightly after (for example, 10 minutes after) the usage end time.

Further, the agent unlocking key setting unit 358 creates the unlocking schedule for disabling the agent unlocking key without waiting for the end of the specific time period after the agent unlocking key is used, and stores the unlocking schedule in the storage unit 30.

After performing step ST674, in step ST675, the transportation unlocking key setting unit 357 creates an unlocking schedule for enabling or disabling the transportation unlocking key on the basis of a predetermined condition, and stores the unlocking schedule in the storage unit 30.

Specifically, the transportation unlocking key setting unit 357 creates an unlocking schedule for disabling the agent unlocking key and then enabling the transportation unlocking key, and stores the unlocking schedule in the storage unit 30. Further, the transportation unlocking key setting unit 357 creates an unlocking schedule for disabling the transportation unlocking key after the transportation unlocking key is used, and stores the unlocking schedule in the storage unit 30.

On the other hand, if it is determined in step ST673 that there is no reservation for delivery or recovery, in step ST676, the transportation unlocking key setting unit 357 creates an unlocking schedule for enabling or disabling the transportation unlocking key on the basis of a predetermined condition, and stores the unlocking schedule in the storage unit 30.

Specifically, the transportation unlocking key setting unit 357 determines a specific time period to enable the transportation unlocking key on the basis of the accommodation reservation information stored in the storage unit 30, crates an unlocking schedule for enabling the transportation unlocking key at the start of the specific time period and disabling the transportation unlocking key at the end of the specific time period, and stores the unlocking schedule in the storage part 30. Here, the specific time period can be determined to be, for example, from slightly before (for example, 10 minutes before) the usage start time of the lockers 510 and 520 to slightly after (for example, 10 minutes after) the usage end time.

After performing the processing in either step ST675 or step ST676, the management server 3 ends the setting processing of the various unlocking keys. In addition, the management server 3 ends the setting processing of the various unlocking key and then ends the unlocking key-related processing.

Returning to the description of FIG. 9, the processing from step ST7 onward will be described.

After performing the unlocking key related processing in step ST6, as illustrated in FIG. 9, the usage fee control system 36 performs usage fee related processing in step ST7.

FIG. 18 is a flowchart illustrating an operation of the usage fee related processing.

In the usage fee related processing, as illustrated in FIG. 18, the usage fee control system 36 performs various processing in steps ST71 to ST74.

In step ST71, the changing unit 361 changes at least one of the usage fees for the lockers 510 and 520 and the usage periods of the lockers 510 and 520 on the basis of a predetermined condition. Specifically, the changing unit 361 employs the condition related to the period such as the off-season and the busy season as the predetermined condition, and changes the usage periods of the lockers 510 and 520 to be lengthened during the off-season and to be shortened during the busy season. In addition, in the present embodiment, the changing unit 361 employs the condition related to the attributes of the user based on the usage situation of the user as the predetermined condition, and changes the usage fees for the lockers 510 and 520 to be discounted to the VIP members.

After performing the processing in step ST71, in step ST72, the sum calculation unit 362 calculates the sum of the usage fees for the lockers 510 and 520 and the usage fee for the room 20.

After performing the processing in step ST72, in step ST73, the settlement receiving unit 363 receives the settlement for the sum of the usage fees calculated by the sum calculation unit 362. In the present embodiment, the settlement receiving unit 363 displays the sum of the usage fees calculated by the sum calculation unit 362 on the touch panel 41 of the user input means 4 (not illustrated). Further, the settlement receiving unit 363 receives the settlement of the sum of the usage fees calculated by the sum calculation unit 362 via the user input means 4.

Further, the settlement receiving unit 363 displays a determination button for receiving the settlement and a cancel button for receiving cancellation of the settlement on the touch panel 41 of the user input means 4 (not illustrated).

The user of room 20 can perform the settlement by pressing the determination button. Further, the user of the room 20 can cancel the settlement by pressing the cancel button.

Then, in step ST73, the management server 3 determines whether the settlement for the sum of the usage fees is received.

If it is determined in step ST73 that the settlement for the sum of the usage fees is received, in other words, if the user of room 20 presses the determination button, the management server 3 ends the usage fee-related processing.

On the other hand, if it is determined in step ST73 that the settlement for the sum of the usage fees is not received, in other words, if the user of room 20 presses the cancel button, in step ST74, the management server 3 cancels all information and notifications regarding the reservation of room 20 and the accommodation means 5. Specifically, the management server 3 deletes various types of information stored in the storage unit 30, such as the facility reservation information, the accommodation reservation information, the transportation schedule, and the unlocking schedule. Further, the management server 3 cancels various notifications transmitted to the delivery agent, the rental agent, and the transportation robot 6. Thereafter, the management server 3 ends the usage fee-related processing.

Note that in the present embodiment, the management server 3 performs the various notifications to the delivery agent, the rental agent, and the transportation robot 6 before receiving the settlement of the sum of the usage fees, and if it is determined in step ST73 that the settlement of the sum of the usage fees is note received, in step ST74, the management server 3 cancels the various notifications. On the other hand, the management server 3 may perform the various notifications to the delivery agent, the rental agent, and the transportation robot 6 after receiving the settlement of the sum of the usage fees.

Then, as illustrated in FIG. 9, the management server 3 performs the processing in step ST1 again after ending the usage fee-related processing.

According to the present embodiment, the following functions and effects can be obtained.

(1) The transportation control unit 323 causes the transportation robot 6 to transport the object from the accommodation means 5 to the room 20 at the reservation date and time of the room 20 on the basis of the facility reservation information stored in the storage unit 30 and the item identification information acquired by the item identification information acquisition unit 322, so that the user can receive the object in the room 20 at the reservation date and time of the room 20 by requesting the delivery agent to deliver the object to the accommodation means 5. Therefore, the on-demand rental facility management system 1 can improve user convenience.

(2) The building unlocking key issuing unit 351 issues the building unlocking key for unlocking the building-side locking device 22 of the building 2 to the user of the room 20 and the transportation robot 6 on the basis of the facility reservation information stored in the storage unit 30, so that the user can enter inside of the building 2, and the transportation control unit 323 can cause the transportation robot 6 to transport the object from the accommodation means 5 to the inside of the building 2 at the reservation date and time of the room 20. Therefore, the on-demand rental facility management system 1 can further improve user convenience.

(3) The facility unlocking key issuing unit 352 issues the facility unlocking key for unlocking the facility-side locking device 202 of the room 20 to the user of the room 20 and the transport robot 6 on the basis of the facility reservation information stored in the storage unit 30, so that the user can enter inside of the room 20, and the transportation control unit 323 can cause the transport robot 6 to transport the object from the accommodation means 5 to the inside of the room 20 at the reservation date and time of the room 20. Therefore, the on-demand rental facility management system 1 can further improve user convenience.

(4) The item identification information acquisition unit 322 acquires the information for identifying the lockers 510 and 520 that accommodate the objects as the item identification information, so that the transportation robot 6 can easily identify the object stored in the accommodation means 5 and simplify a configuration of the on-demand rental facility management system 1, for example, without identifying a shape and the like of the object using technology such as image processing, by acquiring the information for identifying the lockers 510 and 520 that accommodate the objects (for example, information such as locations and identification numbers of the lockers 510 and 520) by the item identification information acquisition unit 322 via the user or the delivery agent.

(5) The accommodation reservation receiving unit 331 stores the accommodation reservation information on the user and the reservation date and time of the lockers 510 and 520 in the storage unit 30 in association with the facility reservation information by receiving the reservation for the lockers 510 and 520 via the user input means 4, so that the user can reserve the lockers 510 and 520 as well as the room 20. Therefore, the user can reliably store the object in the accommodation means 5.

(6) The item identification information acquisition unit 322 acquires the accommodation reservation information stored in the storage unit 30 as the item identification information, so that the transportation robot 6 can easily identify the object stored in the accommodation means 5 and simplify the configuration of the on-demand rental facility management system 1, for example, without identifying the shape and the like of the object using the technology such as the image processing, by acquiring the accommodation reservation information stored in the storage unit 30 as the item identification information by the item identification information acquisition unit 322.

(7) The accommodation reservation information notifying unit (the delivery information notifying unit 342 or the recovery information notifying unit 344) notifies the delivery agent of the accommodation reservation information stored in the storage unit 30, so that the delivery agent can deliver the object to the lockers 510 and 520 reserved by the user on the basis of the accommodation reservation information notified by the accommodation reservation information notifying unit. Therefore, the user can reliably receive the object in the room 20 at the reservation date and time of the room 20 without notifying the delivery agent of the accommodation reservation information.

(8) The availability display unit 333 displays the availability of the lockers 510 and 520 on the touch panel 41 of the user input means 4 on the basis of the accommodation reservation information stored in the storage unit 30, so that the user can reserve the lockers 510 and 520 with reference to the availability of the lockers 510 and 520 displayed on the touch panel 41 of the user input means 4.

(9) The accommodation unit information display unit 334 displays the attributes of the lockers 510 and 520 on the touch panel 41 of the user input means 4 on the basis of the attribute information stored in the storage unit 30, and the accommodation unit selection unit 335 allows the user of the room 20 to select the lockers 510 and 520 displayed on the touch panel 41 of the user input means 4 via the user input means 4, so that the user can select and reserve the lockers 510 and 520 having the attribute desired to be used with reference to the attributes of the plurality of lockers 510 and 520 displayed on the touch panel 41 of the user input means 4.

(10) The accommodation reservation receiving unit 331 receives the reservation for the lockers 510 and 520 at the reservation date and time different from the reservation date and time of the room 20 for which the reservation is received by the facility reservation receiving unit 31, so that the user can store the object in the accommodation means 5, for example, before the reservation date and time of the room 20, and can store the object in the accommodation means 5 after the reservation date and time of the room 20 passes and until the next time the room 20 is used.

(11) The transportation control unit 323 causes the transportation robot 6 to transport the object from the room 20 to the lockers 510 and 520 for which the reservation is received by the accommodation reservation receiving unit 331 after the reservation date and time of the room 20 passes on the basis of the facility reservation information and the accommodation reservation information stored in the storage unit 30, so that the user can accommodate the object in the lockers 510 and 520 for which the reservation is received by the accommodation reservation receiving unit 331 after the reservation date and time of the room 20 passes, without transporting the object from the room 20 to the lockers 510 and 520 by oneself. Therefore, the on-demand rental facility management system 1 can further improve user convenience.

(12) The delivery information notifying unit 342 notifies the delivery agent of the accommodation reservation information on the lockers 510 and 520 of the delivery destination stored in the storage unit 30, and notifies the delivery agent of the accommodation unlocking key, so that the user can cause the delivery agent to deliver the object to the lockers 510 and 520 of the delivery destination without notifying the delivery agent of the lockers 510 and 520 of the delivery destination and the accommodation unlocking key.

(13) The delivery information notifying unit 342 notifies the delivery agent of the collection information, so that the delivery agent can collect the object on the basis of the collection information. Therefore, the user can cause the delivery agent to collect the object, for example, from the user's home without directly requesting the delivery agent to collect the object, so that the on-demand rental facility management system 1 can further improve user convenience.

(14) The recovery information notifying unit 344 notifies the delivery agent of the accommodation reservation information on the lockers 510 and 520 of the recovery destination stored in the storage unit 30, and notifies the delivery agent of the accommodation unlocking key, so that the user can cause the delivery agent to recover the object from the lockers 510 and 520 of the recovery destination without informing the delivery agent of the lockers 510 and 520 of the recovery destination and the accommodation unlocking key.

(15) The recovery information notifying unit 344 notifies the delivery agent of the shipping information, so that the delivery agent can ship the object on the basis of shipping address information. Therefore, the user can cause the delivery agent to ship the object to, for example, the user's home without directly requesting the delivery agent to ship the object, so that the on-demand rental facility management system 1 can further improve user convenience.

(16) The rental information acquisition unit 345 acquires the rental information on the rental item that can be rented at the reservation date and time of the lockers 510 and 520 on the basis of the accommodation reservation information stored in the storage unit 30 and stores the rental information in the storage unit 30, and the rental information display unit 346 displays the rental item that can be rented at the reservation date and time of the lockers 510 and 520 on the touch panel 41 of the user input means 4 on the basis of the rental information stored in the storage unit 30. Then, the rental item selection unit 347 allows the user of the room 20 to select the rental item displayed on the touch panel 41 of the user input means 4 via the user input means 4. Therefore, the user can select the rental item desired to be used with reference to the rental item displayed on the touch panel 41 of the user input means 4. Further, since the object is the rental item selected by the rental item selection unit 347, the user can cause the rental agent (the delivery agent) to deliver and recover the rental item. Therefore, the on-demand rental facility management system 1 can further improve user convenience.

(17) The transportation unlocking key issuing unit 355 issues the transportation unlocking key to the transportation robot 6, and the agent unlocking key issuing unit 356 issues the agent unlocking key different from the transportation unlocking key to the agent, so that the on-demand rental facility management system 1 can suppress problems such as the object being taken away by the agent, and can improve safety.

(18) The agent unlocking key setting unit 358 enables or disables the agent unlocking key on the basis of the predetermined condition, so that the on-demand rental facility management system 1 can suppress unlocking of the lockers 510 and 520 by the agent, and can improve safety of the lockers 510 and 520.

(19) The agent unlocking key setting unit 358 enables the agent unlocking key at the start of the specific time period, and disables the agent unlocking key at the end of the specific time period, so that the on-demand rental facility management system 1 can suppress unlocking of the lockers 510 and 520 by the agent outside of the specific time period, and can improve the safety of the lockers 510 and 520.

(20) The agent unlocking key setting unit 358 disables the agent unlocking key after the agent unlocking key is used, so that a validity period of the agent unlocking key can be shortened compared to, for example, a case of disabling the agent unlocking key at the end of the specific time period. Therefore, the on-demand rental facility management system 1 can suppress unlocking of the lockers 510 and 520 by the agent, and can improve safety of the lockers 510 and 520.

(21) Since the transportation unlocking key setting unit 357 enables the transportation unlocking key after disabling the agent unlocking key, the agent unlocking key and the transportation unlocking key are not enabled at the same time. Therefore, the on-demand rental facility management system 1 can suppress unlocking of the lockers 510 and 520 by the agent, and can improve safety of the lockers 510 and 520.

(22) The changing unit 361 changes at least one of the usage fee for the lockers 510 and 520 and the usage period of the lockers 510 and 520 on the basis of the predetermined condition, so that the on-demand rental facility management system 1 can change at least one of the usage fee for the lockers 510 and 520 and the usage period of the lockers 510 and 520 on the basis of, for example, the attributes of the user such as being a VIP, and can promote use of the lockers 510 and 520 by the user of the room 20.

(23) The location information display unit 332 displays the placement locations of the first accommodation means 51 and the second accommodation means 52 on the touch panel 41 of the user input means 4 on the basis of the location information stored in the storage unit 30, so that the user can select and reserve the accommodation means 5 desired to be used with reference to the placement locations of the first accommodation means 51 and the second accommodation means 52 displayed on the touch panel 41 of the user input means 4. Therefore, the on-demand rental facility management system 1 can further improve user convenience.

(24) The sum calculation unit 362 calculates the sum of the usage fee for the lockers 510 and 520 and the usage fee for the room 20, and the settlement receiving unit 363 receives the settlement for the sum of the usage fees calculated by the sum calculation unit 362, so that the user can verify the sum of the usage fee for the lockers 510 and 520 and the usage fee for the room 20, and can pay the usage fees in one settlement.

### Second Embodiment

Hereinafter, a second embodiment of the present invention will be described with reference to the drawings.

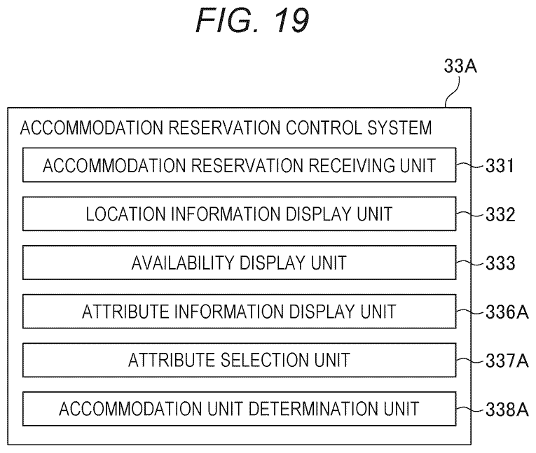

FIG. 19 is a block diagram illustrating functions of the accommodation reservation control system according to the second embodiment of the present invention.

In the first embodiment, the accommodation reservation control system 33 includes the accommodation reservation receiving unit 331, the location information display unit 332, the availability display unit 333, the accommodation unit information display unit 334, and the accommodation unit selection unit 335.

On the other hand, in the present embodiment, as illustrated in FIG. 19, an accommodation reservation control system 33A is different from the first embodiment in that it includes the accommodation reservation receiving unit 331, the location information display unit 332, the availability display unit 333, an attribute information display unit 336A, an attribute selection unit 337A, and an accommodation unit determination unit 338A.

Note that in the following description, parts that have already been described are given the same reference numerals, and description thereof will be omitted.

The attribute information display unit 336A displays the attributes of the lockers 510 and 520 on the touch panel 41 of the user input means 4 on the basis of the attribute information stored in the storage unit 30. Here, the attributes of the lockers 510 and 520 are attributes for selecting the lockers 510 and 520. Specifically, the attributes of the lockers 510 and 520 can include, for example, the features such as the positions, sizes, and shapes of the lockers 510 and 520, as well as the functions such as refrigeration, freezing, and temperature and humidity adjustment.

The attribute selection unit 337A allows the user of the room 20 to select the attributes of the lockers 510 and 520 displayed on the touch panel 41 of the user input means 4 via the user input means 4.

The accommodation unit determination unit 338A determines the lockers 510 and 520 to be used by the user of the room 20 on the basis of the attributes of the lockers 510 and 520 selected by the user of the room 20.

In the present embodiment, the management server 3 performs processing different from that in the first embodiment. Specifically, in the present embodiment, the locker reservation processing is different from that in the first embodiment. The contents of the locker reservation processing in the present embodiment will be described below.

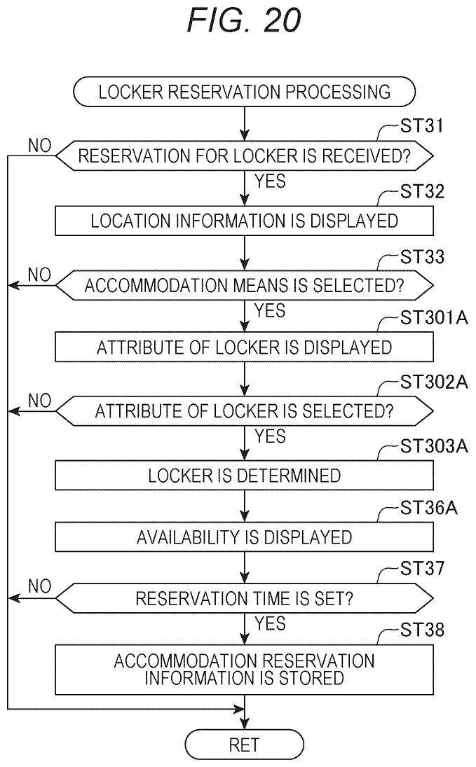

FIG. 20 is a flowchart illustrating the operation of the locker reservation processing.

In the locker reservation processing, as illustrated in FIG. 20, the accommodation reservation control system 33A performs the various processing in steps ST31 to ST38. In the present embodiment, the processing in steps ST31 to ST33 and the processing in steps ST36A to ST38 are performed in the same manner as in the first embodiment. Note that the present embodiment is different from the first embodiment in that the processing in steps ST301A to ST303A are performed after the processing in steps ST31 to ST33 are performed and before the processing in step ST36A is performed.

The management server 3 determines in step ST33 whether the selection of the accommodation means 5 is received.

If it is determined in step ST33 that the selection of the accommodation means 5 is not received, in other words, if the user of the room 20 presses the cancel button B2, the management server 3 ends the locker reservation processing without performing the processing from step ST301A onward.

On the other hand, if it is determined in step ST33 that the selection of the accommodation means 5 is received, in other words, if the user of the room 20 selects one of the first accommodation means 51 and the second accommodation means 52 and then presses the determination button B1, in step ST301A, the attribute information display unit 336A displays the attributes of the lockers 510 and 520 on the touch panel 41 of the user input means 4 on the basis of the attribute information stored in the storage unit 30

Here, the storage unit 30 stores in advance the attribute information on the attributes of the lockers 510 and 520 for selecting the lockers 510 and 520.

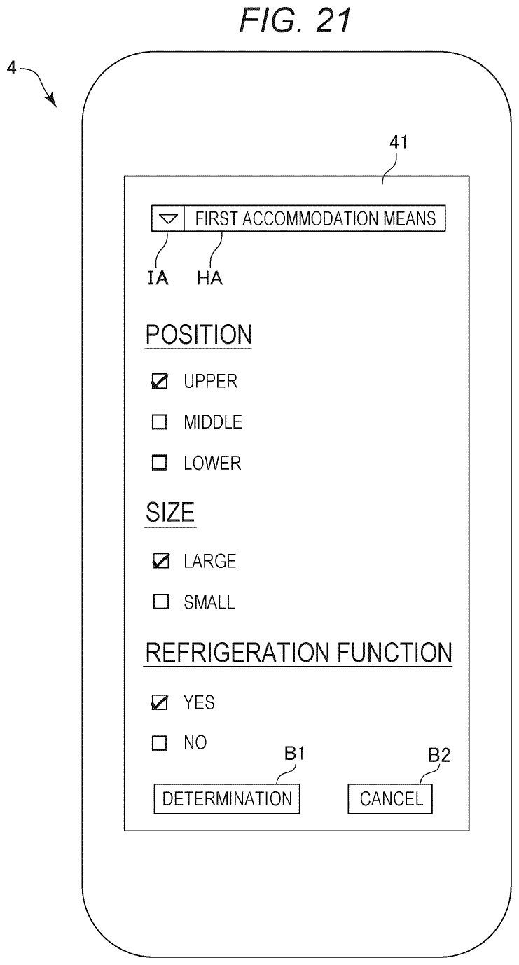

FIG. 21 is a diagram illustrating the display unit of the user input means displaying the attributes of the lockers in the first accommodation means.

As illustrated in FIG. 21, the attribute information display unit 336A displays the positions, sizes, and refrigeration functions of the lockers 510 and 520 in the first accommodation unit 51 as the attributes of the lockers 510 and 520 in the first accommodation means 51 on the touch panel 41 of the user input means 4. Further, the attribute information display unit 336A displays the determination button B1 for receiving selection of the lockers 510 and 520 and the cancel button B2 for receiving cancellation of the reservation for the lockers 510 and 520, on the touch panel 41 of the user input means 4.

Here, in an example of FIG. 21, the attribute information display unit 336A displays the first accommodation means 51 selected by the user of the room 20 in an accommodation means display section HA disposed at the upper end of the touch panel 41 of the user input means 4. The accommodation means display section HA includes an accommodation means selection section IA disposed at the left end of the accommodation means display section HA. The user of the room 20 can select another accommodation means 5 by pressing the accommodation means selection section IA, and can display the attributes of the lockers 510 and 520 in the accommodation means 5 on the touch panel 41 of the user input means 4.

Further, the attribute selection unit 337A displays on the touch panel 41 of the user input means 4 a checkbox for allowing the user of the room 20 to select the attributes of the lockers 510 and 520 displayed on the touch panel 41 of the user input means 4 via the user input means 4.

Specifically, the attribute selection unit 337A displays three checkboxes of “UPPER”, “MIDDLE”, and “LOWER” regarding position attributes of the lockers 510 and 520 on the touch panel 41 of the user input means 4. Further, the attribute selection unit 337A displays two checkboxes of “LARGE” and “SMALL” regarding size attributes of the lockers 510 and 520 on the touch panel 41 of the user input means 4. Furthermore, the attribute selection unit 337A displays two checkboxes of “YES” and “NO” regarding refrigeration function attributes of the lockers 510 and 520 on the touch panel 41 of the user input means 4.

When the user of the room 20 selects the attributes of the lockers 510 and 520, the user can select the attributes of the lockers 510 and 520 by checking the checkboxes to select the attributes of the lockers 510 and 520 displayed on the touch panel 41 of the user input means 4, and then pressing the determination button B1.

Note that in the example of FIG. 21, the user of the room 20 selects the position attribute as “UPPER”, the size attribute as “LARGE”, and the refrigeration function attribute as “YES”, but may select other attributes. Further, in the present embodiment, the checkboxes can be selected redundantly, but only one of them may be able to be selected for each attribute.

On the other hand, when the user of the room 20 does not select the attributes of the lockers 510 and 520, the user can cancel the reservation of the lockers 510 and 520 by pressing the cancel button B2.

After performing step ST301A, as illustrated in FIG. 20, the management server 3 determines whether selection of the attributes of the lockers 510 and 520 is received in step ST302A.

If it is determined in step ST302A that the selection of the attributes of the lockers 510 and 520 is not received, in other words, if the user of room 20 presses the cancel button B2, the management server 3 ends the locker reservation processing without performing the processing from step ST303A onward.

On the other hand, if it is determined in step ST302A that the selection of the attributes of the lockers 510 and 520 is received, in other words, if the user of room 20 checks the checkboxes and then presses the determination button B1, in step ST303A, the accommodation unit determination unit 338A determines the lockers 510 and 520 to be used by the user of the room 20 on the basis of the attributes of the lockers 510 and 520 selected by the user of the room 20.

Note that when the accommodation unit determination unit 338A detects the plurality of lockers 510 and 520 matching the attributes of the lockers 510 and 520 selected by the user of the room 20, it randomly determines the lockers 510 and 520 to be used by the user of the room 20 from the plurality of lockers 510 and 520. Further, when the accommodation unit determination unit 338A cannot detect the lockers 510 and 520 matching the attributes of the lockers 510 and 520 selected by the user of the room 20, it may be configured to issue a warning to the user of the room 20 via the touch panel 41 of the user input means 4 and allow the user to reselect the attributes of the lockers 510 and 520, or may be configured to issue the warning and end the locker reservation processing.

After performing the processing of step ST303A, in step ST36A, the availability display unit 333 displays the availability of the lockers 510 and 520 determined in step ST303A to be used by the user of the room 20 on the touch panel 41 of the user input means 4 on the basis of the accommodation reservation information stored in the storage unit 30.

Note that the availability display unit 333 has the same configuration as that of the first embodiment. For example, when the lockers 510 and 520 determined in step ST303A to be used by the user of the room 20 are the locker 510 labeled AA, as illustrated in FIG. 13 in the first embodiment, the availability of the lockers 510 and 520 at the reservation date and time of the room 20 is displayed on the touch panel 41 of the user input means 4.

Thereafter, the management server 3 performs the processing from step ST37 onward as in the first embodiment.

Also in such a second embodiment, the same operations and effects as (1) to (8) and (10) to (24) in the first embodiment can be obtained, as well as the following operations and effects can be obtained.

(25) The attribute information display unit 336A displays the attributes of the lockers 510 and 520 on the touch panel 41 of the user input means 4 on the basis of the attribute information stored in the storage unit 30, and the attribute selection unit 337A allows the user of the room 20 to select via the user input means 4 the attributes of the lockers 510 and 520 displayed on the touch panel 41 of the input means 4. Then, accommodation unit determination unit 338A determines the lockers 510 and 520 to be used by the user of room 20 on the basis of the attributes of the lockers 510 and 520 selected by the user of the room 20. Therefore, the user can cause the accommodation unit determination unit 338A to automatically determine and reserve the lockers 510 and 520 having desired attributes by selecting the attributes of the lockers 510 and 520 desired to be used with reference to the attributes of the plurality of lockers 510 and 520 displayed on the touch panel 41 of the input means 4.

### Modification of Embodiment

It should be noted that the present invention is not limited to the above-described embodiments, and includes modifications, improvements, and the like within the scope of achieving the object of the present invention.

For example, in the above embodiments, the on-demand rental facility is the room 20 of the building 2, but it may be a conference room, a training room, a karaoke room, a rental office, a reading space, or the like, may be an outdoor space such as a tennis court, a baseball field, an athletic field, or a parking lot, or may be a movable property such as a rental car or a rental bicycle.

In each of the above embodiments, a configuration is exemplified in which the management server 3 is connected to the user input means 4 and the communication terminal device 203 via the Internet 7, which is the communication line. The management server may be a distributed management type server, for example, a server using a distributed transaction ledger typified by blockchain can be used, and it may be any server that can transmit and receive various commands to and from the communication terminal device 203 and process them, and manage the on-demand rental facility.

In each of the above embodiments, the transportation robot 6 is employed as the transportation means, and can run on the floor surface, but for example, a drone or the like may be employed and be able to fly in space. In short, it is sufficient that the transportation means can move between the on-demand rental facility and the storage location to transport the items.

In each of the above embodiments, the lockers 510 and 520 are employed as the storage locations for storing the items, but any place such as a shelf or a floor surface may be employed as long as the items delivered by the delivery agent can be stored.

In each of the above embodiments, the accommodation means 5 includes the first accommodation means 51 and the second accommodation means 52, but the accommodation means 5 may have only one accommodation means, and may have three or more of storage means. Further, although the accommodation means 5 has the lockers 510 and 520 as the plurality of accommodation units, it need not have the plurality of accommodation units. In short, it is sufficient that the accommodation means has the accommodation unit as the storage location for storing the items.

In each of the above embodiments, the management server 3 includes the location information display unit 332, and the location information display unit 332 displays the placement locations of the first accommodation means 51 and the second accommodation means 52 on the touch panel 41 of the user input means 4 on the basis of the location information stored in the storage unit 30. In contrast, for example, when it is not necessary to notify the user of the on-demand rental facility of the placement location of the accommodation means, the management server does not need to include the location information display unit.

In each of the above embodiments, the management server 3 includes the building unlocking key issuing unit 351 for issuing the building unlocking key for unlocking the building-side locking device 22 of the building 2, and the facility unlocking key issuing unit 352 for issuing the facility unlocking key for unlocking the facility-side locking device 202 of the room 20. In contrast, when a building and an on-demand rental facility that do not include a locking device are employed, the management server need not include the building unlocking key issuing unit and the facility unlocking key issuing unit. Further, when a building and an on-demand rental facility that include a physical key locking device are employed, the transportation means may have a function of locking and unlocking such a locking device.

In each of the above embodiments, the item identification information acquisition unit 322 acquires the accommodation reservation information stored in the storage unit 30 as the item identification information. In contrast, for example, when the object is accommodated on the shelf or on the floor surface, the item identification information acquisition unit may be notified of the information for identifying the storage location that accommodates the object by the user of the on-demand rental facility, the delivery agent, or the like and acquire this information as the item identification information. In this case, the transportation means may be configured to identify the object stored in the storage location, for example, by identifying the shape or the like of the object using the technology such as the image processing.

In each of the above embodiments, the accommodation reservation information notifying unit (the delivery information notifying unit 342 or the recovery information notifying unit 344) notifies the delivery agent of the accommodation reservation information stored in the storage unit 30. In contrast, the management server need not include the accommodation reservation information notifying unit. In this case, the user of the on-demand rental facility only needs to notify the delivery agent of the accommodation reservation information by oneself.

In each of the above embodiments, the management server 3 includes the availability display unit 333 for displaying the availability of the lockers 510 and 520 on the touch panel 41 of the user input means 4. In contrast, for example, when a storage location that need not to be checked for availability is employed, the management server need not include the availability display unit.

In each of the above embodiments, the management server 3 includes various functions for receiving the delivery, recovery, and rental of the object, but when the delivery, recovery, and rental of the object is not received, these functions may not be provided.

In each of the above embodiments, the management server 3 includes the usage fee control system 36 for changing the usage fees of the lockers 510 and 520 and the usage periods of the lockers 510 and 520, and settling the usage fees of the lockers 510 and 520 and the usage fee of the room 20. The usage fee control system 36 may have only a part of functions such as a function to settle the usage fees. Further, the management server 3 may not include the usage fee control system 36, and in this case, an administrator of the on-demand rental facility may receive the usage fee by oneself.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. An on-demand rental facility management system comprising: on-demand rental facility in which usage time is set and facility is rented to a user; a management server for managing the on-demand rental facility; and a user input means that is connected to the management server via a communication line and receives information input by the user of the on-demand rental facility, the on-demand rental facility management system comprising:
a storage location for storing an item delivered by a delivery agent; and
a transportation means that is connected to the management server via the communication line and moves between the on-demand rental facility and the storage location to transport the item, wherein
the management server includes:
a storage unit for storing information;
a facility reservation receiving unit for storing facility reservation information on the user and reservation date and time of the on-demand rental facility in the storage unit by receiving a reservation for the on-demand rental facility via the user input means;
a transportation receiving unit for receiving transportation of an object, which is an item related to the user of the on-demand rental facility, via the user input means;
an item identification information acquisition unit for acquiring item identification information for identifying the object stored in the storage location when the transportation of the object is received by the transportation receiving unit; and
a transportation control unit for causing the transportation means to transport the object from the storage location to the on-demand rental facility at the reservation date and time of the on-demand rental facility on the basis of the facility reservation information stored in the storage unit and the item identification information acquired by the item identification information acquisition unit.

2. The on-demand rental facility management system according to claim 1, wherein:
the on-demand rental facility is a room provided inside a building,
the building includes a locking device of the building for locking and unlocking the building, and
the management server includes a building unlocking key issuing unit for issuing a building unlocking key for unlocking the locking device of the building to the user of the on-demand rental facility and the transportation means on the basis of the facility reservation information stored in the storage unit.

3. The on-demand rental facility management system according to claim 1, wherein:
the on-demand rental facility includes a locking device of the on-demand rental facility for locking and unlocking the on-demand rental facility, and
the management server includes a facility unlocking key issuing unit for issuing a facility unlocking key for unlocking the locking device of the on-demand rental facility to the user of the on-demand rental facility and the transportation means on the basis of the facility reservation information stored in the storage unit.

4. The on-demand rental facility management system according to claim 1, wherein:
an accommodation means that is connected to a communication line and has an accommodation unit as a plurality of the storage locations for accommodating items, wherein
the item identification information acquisition unit acquires information for identifying the accommodation unit that accommodates the object as the item identification information.

5. The on-demand rental facility management system according to claim 4, wherein:
the management server includes an accommodation reservation receiving unit for storing accommodation reservation information on a user and reservation date and time of the accommodation unit in the storage unit in association with the facility reservation information by receiving a reservation for the accommodation unit via the user input means, and
the item identification information acquisition unit acquires the accommodation reservation information stored in the storage unit as the item identification information.

6. The on-demand rental facility management system according to claim 5, wherein: the management server includes an accommodation reservation information notifying unit for notifying the delivery agent of the accommodation reservation information stored in the storage unit.

7. The on-demand rental facility management system according to claim 5, wherein:
the user input means includes a display unit for displaying information, and
the management server includes an availability display unit for displaying availability of the accommodation unit on the display unit of the user input means on the basis of the accommodation reservation information stored in the storage unit.

8. The on-demand rental facility management system according to claim 7, wherein:
the storage unit stores attribute information on an attribute of the accommodation unit for selecting the accommodation unit, and
the management server includes:
an accommodation unit information display unit for displaying the attribute of the accommodation unit on the display unit of the user input means on the basis of the attribute information stored in the storage unit; and
an accommodation unit selection unit for allowing the user of the on-demand rental facility to select the accommodation unit displayed on the display unit of the user input means via the user input means.

9. The on-demand rental facility management system according to claim 7, wherein:
the storage unit stores the attribute information on the attribute of the accommodation unit for selecting the accommodation unit, and
the management server includes:
an attribute information display unit for displaying the attribute of the accommodation unit on the display unit of the user input means on the basis of the attribute information stored in the storage unit;
an attribute selection unit for allowing the user of the on-demand rental facility to select the attribute of the accommodation unit displayed on the display unit of the user input means via the user input means; and
an accommodation unit determination unit for determining the accommodation unit to be used by the user of the on-demand rental facility on the basis of the attribute of the accommodation unit selected by the user of the on-demand rental facility.

10. The on-demand rental facility management system according to claim 5, wherein: the accommodation reservation receiving unit receives the reservation for the accommodation unit at reservation date and time different from the reservation date and time of the on-demand rental facility for which the reservation is received by the facility reservation receiving unit.

11. The on-demand rental facility management system according to claim 5, wherein: the transportation control unit causes the transportation means to transport the object from the on-demand rental facility to the accommodation unit for which the reservation is received by the accommodation reservation receiving unit after the reservation date and time of the on-demand rental facility passes on the basis of the facility reservation information and the accommodation reservation information stored in the storage unit.

12. The on-demand rental facility management system according to claim 5, wherein:
the accommodation unit includes a locking device for locking and unlocking the accommodation unit, and
the management server includes:
a delivery receiving unit for receiving delivery of the object to the accommodation unit for which the reservation is received by the accommodation reservation receiving unit;
an accommodation unlocking key issuing unit for issuing an accommodation unlocking key for unlocking the locking device of the accommodation unit that is a delivery destination for which the delivery is received by the delivery receiving unit; and
a delivery information notifying unit for notifying the delivery agent of the accommodation reservation information on the accommodation unit of the delivery destination stored in the storage unit, and notifying the delivery agent of the accommodation unlocking key.

13. The on-demand rental facility management system according to claim 12, wherein:
the delivery receiving unit receives collection information on collection of the object, and
the delivery information notifying unit notifies the delivery agent of the collection information.

14. The on-demand rental facility management system according to claim 5, wherein:
the accommodation unit includes a locking device for locking and unlocking the accommodation unit,
the management server includes:
a recovery receiving unit for receiving recovery of the object in the accommodation unit for which the reservation is received by the accommodation reservation receiving unit;
an accommodation unlocking key issuing unit for issuing an accommodation unlocking key for unlocking the locking device of the accommodation unit that is a recovery destination for which the recovery is received by the recovery receiving unit; and
a recovery information notifying unit for notifying the delivery agent of the accommodation reservation information on the accommodation unit of the recovery destination stored in the storage unit, and notifying the delivery agent of the accommodation unlocking key.

15. The on-demand rental facility management system according to claim 14, wherein:
the recovery receiving unit receives shipping information on shipping of the object, and
the recovery information notifying unit notifies the delivery agent of the shipping information.

16. The on-demand rental facility management system according to claim 5, wherein:
the accommodation unit includes a locking device for locking and unlocking the accommodation unit,
the management server includes:
a delivery receiving unit for receiving delivery of the object to the accommodation unit for which the reservation is received by the accommodation reservation receiving unit;
an accommodation unlocking key issuing unit for issuing an accommodation unlocking key for unlocking the locking device of the accommodation unit that is a delivery destination for which the delivery is received by the delivery receiving unit;
a delivery information notifying unit for notifying the delivery agent of the accommodation reservation information on the accommodation unit of the delivery destination stored in the storage unit, and notifying the delivery agent of the accommodation unlocking key;
a recovery receiving unit for receiving recovery of the object in the accommodation unit for which the reservation is received by the accommodation reservation receiving unit;
an accommodation unlocking key issuing unit for issuing an accommodation unlocking key for unlocking the locking device of the accommodation unit that is a recovery destination for which the recovery is received by the recovery receiving unit;
a recovery information notifying unit for notifying the delivery agent of the accommodation reservation information on the accommodation unit of the recovery destination stored in the storage unit, and notifying the delivery agent of the accommodation unlocking key;
a rental information acquisition unit for acquiring rental information on a rental item that can be rented at the reservation date and time of the accommodation unit on the basis of the accommodation reservation information stored in the storage unit and storing the rental information in the storage unit;
a rental information display unit for displaying the rental item that can be rented at the reservation date and time of the accommodation unit on a display unit of the user input means on the basis of the rental information stored in the storage unit; and
a rental item selection unit for allowing the user of the on-demand rental facility to select the rental item displayed on the display unit of the user input means via the user input means, and
the object is the rental item selected by the rental item selection unit.

17. The on-demand rental facility management system according to claim 12, wherein:
the accommodation unlocking key issuing unit includes:
a transportation unlocking key issuing unit for issuing, to the transportation means, a transportation unlocking key for unlocking the locking device of the accommodation unit for which the reservation is received by the accommodation reservation receiving unit; and
an agent unlocking key issuing unit for issuing, to the delivery agent, an agent unlocking key for unlocking the locking device of the accommodation unit for which the reservation is received by the accommodation reservation receiving unit, and being different from the transportation unlocking key.

18. The on-demand rental facility management system according to claim 17, wherein:
the management server includes an agent unlocking key setting unit for enabling or disabling the agent unlocking key on the basis of a predetermined condition.

19. The on-demand rental facility management system according to claim 18, wherein:
the agent unlocking key setting unit determines a specific time period to enable the agent unlocking key on the basis of the accommodation reservation information stored in the storage unit, enables the agent unlocking key at a start of the specific time period, and disables the agent unlocking key at an end of the specific time period.

20. The on-demand rental facility management system according to claim 18, wherein:
the agent unlocking key setting unit disables the agent unlocking key after the agent unlocking key is used.

21. The on-demand rental facility management system according to claim 17, wherein:
the management server includes a transportation unlocking key setting unit for enabling or disabling the transportation unlocking key on the basis of a predetermined condition, and
the transportation unlocking key setting unit enables the transportation unlocking key after disabling the agent unlocking key.

22. The on-demand rental facility management system according to claim 5, wherein:
the management server includes a changing unit for changing at least one of a usage fee for the accommodation unit and a usage period of the accommodation unit on the basis of a predetermined condition.

23. The on-demand rental facility management system according to claim 5, wherein:
the accommodation means includes:
a first accommodation means disposed at a predetermined location; and
a second accommodation means disposed at a location different from the first accommodation means,
the storage unit stores location information on placement locations of the first accommodation means and the second accommodation means, and
the management server includes a location information display unit for displaying the placement locations of the first accommodation means and the second accommodation means on a display unit of the user input means on the basis of the location information stored in the storage unit.

24. The on-demand rental facility management system according to claim 5, wherein:
the management server includes:
a sum calculation unit for calculating a sum of a usage fee for the accommodation unit and a usage fee for the on-demand rental facility; and
a settlement receiving unit for receiving settlement for the sum of usage fees calculated by the sum calculation unit.
